(19) United States
(12) Patent Application Publication
(10) Pub. No.: US 2026/0097663 A1
(43) Pub. Date: Apr. 9, 2026

(54) A TRAILER AND AN ASSOCIATED CONTROLLER

(71) Applicants: Abhijeet Arun KHOTKAR, Ellerslie, Auckland (NZ); Alan John GRIMMER, Ellerslie, Auckland (NZ); Danushka ABEYSURIYA, Ellerslie, Auckland (NZ)

(72) Inventors: Abhijeet Arun KHOTKAR, Ellerslie, Auckland (NZ); Alan John GRIMMER, Ellerslie, Auckland (NZ); Danushka ABEYSURIYA, Ellerslie, Auckland (NZ)

(21) Appl. No.: 19/113,072

(22) PCT Filed: Sep. 22, 2023
(86) PCT No.: PCT/IB2023/059420

§ 371 Date: Mar. 19, 2025

(30) Foreign Application Priority Data
Sep. 23, 2022 (NZ) 792746

(51) Int. Cl. B60L 15/20; B60D 1/24; B60K 1/02; B60L 50/60; B62D 11/04; B62D 33/04; B62D 59/04; B62D 63/08; G06T 7/55; G06T 7/70; G06V 20/58

(52) U.S. Cl. CPC B60L 15/2009; B60D 1/24; B60K 1/02; B60L 50/60; B62D 11/04; B62D 33/04; B62D 59/04; B62D 63/08; G06T 7/55; G06T 7/70; B60L 2200/28; B60L 2220/42; G06T 2207/30252; G06V 20/58

(57) ABSTRACT

A trailer configured to be towed by a towing vehicle and carry one or more goods. The trailer comprises a chassis, a hitch to couple the trailer to a towing vehicle and a receptacle mounted on the chassis and defining a space to hold goods. The trailer comprises at least two wheels. An electric motor is mounted on each wheel, and the electric motors may be independently controlled to each wheel. The trailer comprises: one or more force sensors mounted on the trailer, at least one optical sensor mounted on the trailer, and optionally may include other sensors such as acoustic sensors. The trailer comprises a controller that is configured to process sensor inputs and determine a force on the hitch applied by the towing vehicle, determine an orientation of the towing vehicle and control the electric motor based on the determined force and orientation.

### FIELD OF THE INVENTION

The present disclosure relates to a towed vehicle and in particular a towed trailer. The present disclosure also relates to a controller associated with the trailer, wherein the controller is configured to control one or more functions of the trailer.

### BACKGROUND

Trailers are commonly used vehicles for recreational and commercial purposes.

Recreational trailers are used for recreational purposes such as for example, hauling boats, transporting camping equipment, transporting sports equipment etc. Commercial trailers are used for long distance transport of goods. Current trailers are passive vehicles that are not driven and towed by a towing vehicle.

Towing a trailer places significant drag on the towing vehicle. This increased loading due to drag results in a reduction in fuel efficiency of the towing vehicle, and can also reduce the available power for other functions such acceleration for climbing hills etc. The reduced fuel efficiency causes an increase in fuel usage. The increased drag and reduced power are particularly noticeable in electric vehicles and hybrids, as these are more power limited than internal combustion engine vehicles. Further in internal combustion engines this can reduce fuel efficiency and increase fuel consumption for internal combustion engine vehicles.

Fuel efficiency and usage of fuel is major consideration for commercial trailers. Fuel usage is a major cost for transportation companies that utilise commercial trailers to transport goods over long distances e.g., between cities or cross country. The drag from trailers can increase fuel costs and thereby increase cost of transporting goods.

Similarly, electric trucks such as ones manufactured by Tesla, Freightliner, Volvo etc. have limitations on the size of trailers that can be hauled and the distances that can be travelled to the increased power draw due to drag from a trailer.

### SUMMARY OF THE INVENTION

Electric vehicles are gaining popularity. Vehicle manufacturers are trending toward making electric vehicles due to the need to reduce reliance on fossil fuels and develop vehicles that have reduced emissions. Electric vehicles are generally quite energy efficient. Compared to an internal combustion engine vehicle, an electric vehicle comprises less energy density in a battery than the energy density in fuel of internal combustion engine vehicles. Towing trailers with electric vehicles can be challenging due to the increased power draw required by the drag from the trailer. There is also a limitation on the number of batteries and motors that can be used in a vehicle such as a truck, SUV, car etc. Hence, electric vehicles are not often used to tow trailers.

The present disclosure relates to a towed vehicle and in particular a towed trailer. The present disclosure is directed to a driven trailer. The trailer is an electric trailer. The trailer is driven by one or more electric motors to reduce the load on the pulling vehicle. The present disclosure also relates to a controller associated with the trailer that is configured to control one or more functions of the trailer. The trailer as described herein may be a driven trailer that may be driven by one or more electric motors associated with the trailer. The controller may be configured to control operation of the motors to control movement i.e., locomotion of the trailer and/or control other functions of the trailer. The electric motors reduce the pulling load i.e., can assist by providing thrust to propel the trailer.

The trailer as described herein may be a recreational trailer. The trailer as described herein may also a commercial trailer e.g., a semi-trailer or other large trailer. The trailer may be towed by a towing vehicle. The towing vehicle may be a car, an SUV, truck, or any other suitable vehicle. The recreational trailer may be configured to be towed by a car, SUV, pick up or other such vehicle. The semi-trailer is configured to be pulled by a truck. The towing vehicle can be propelled by any means e.g., diesel or gasoline or may be an electric vehicle.

The trailer of the present disclosure may be a driven trailer. The trailer comprises: a chassis, a receptacle mounted on the chassis and supported by the chassis, a plurality of wheels mounted to the chassis and a hitch. The trailer is connectable to the towing vehicle by the hitch. The trailer further comprises one or more electric motors that are connected to the one or more wheels, or to a shaft of the wheels, to drive one or more wheels. The one or more electric motors are controlled by a control signal from a controller. The trailer comprises one or more sensors configured to sense forces from the towing vehicle upon the hitch as the trailer is towed. The sensors may be mounted on the hitch or adjacent the hitch. The sensors are configured to sense forces on the hitch due to the towing vehicle. The controller is configured to receive signals from the sensor and control the one or more electric motors to drive the wheels forward or backward based on the sensed pull force signals from the one or more sensors.

According to a first aspect of the disclosure relates to A trailer configured to be towed by a towing vehicle, the trailer comprising:
a chassis,
a hitch to couple the trailer to a towing vehicle,
a receptacle mounted on the chassis and defining a space to hold goods,
a wheel assembly coupled to the chassis, the wheel assembly comprising at least a first wheel and a second wheel,
at least one electric motor connected to the wheels of the wheel assembly, the electric motor configured to drive at least one wheel of the wheel assembly,
at least one battery, the battery electrically coupled to the electric motor and the electric motor configured to draw power from the battery to drive the motor,
one or more force sensors mounted on the trailer,
at least one optical sensor and optionally other additional sensors mounted on the trailer,
a controller arranged in communication with the plurality of force sensors and the at least one optical sensor and optionally other additional sensors, the controller configured to receive and process signals received from the force sensors and the optical sensor and optionally other additional sensors,
the controller electrically coupled to the electric motor and configured to control operation of the electric motor,
wherein the controller further configured to:
   determine a force on the hitch applied by the towing vehicle, based on processing signals received from the one or more force sensors,
   determine an orientation of the towing vehicle based on processing images received from the optical sensor and optionally other additional sensors
   control the electric motor based on the determined force and orientation.

In one configuration the force sensors are mounted on the hitch.

In one configuration the force sensors are configured to determine a linear force on the hitch, wherein the force on the hitch is applied by the towing vehicle.

In one configuration the controller is configured to determine a magnitude and direction of the force on the hitch applied by the towing vehicle.

In one configuration the one or more force sensors are load cells.

In one configuration one or more force sensors are strain gauges. Alternatively, any other suitable force sensors may be used. The force sensors may be single axis sensors or multi axis sensors.

In one configuration the trailer comprises four force sensors mounted on the hitch, the four force sensors are configured to sense a force on the hitch by the towing vehicle.

In one example configuration the controller is configured to determine at least one or both of a magnitude and direction of a force sensed by each force sensor.

In one configuration the controller is configured to determine a resultant force based on the force sensed at each force sensor, the controller further configured to determine at least one or more of a magnitude and direction of the resultant force, wherein the resultant force is representative of a force applied to the trailer by the towing vehicle.

In one configuration the trailer comprises a hitch plate and a coupling bar extending outwardly from the hitch plate, the coupling bar configured to couple to the towing vehicle, the force sensors being sandwiched between the hitch plate and either of the receptacle or chassis such that the hitch plate is connected to either the receptacle or chassis via the force sensors, wherein the force sensors are configured to sense the force to the coupling bar by the towing vehicle.

In one configuration each force sensor is mounted at or adjacent a corner of the hitch plate.

In one configuration the hitch plate is substantially square in shape and the force sensors are mounted equidistant to each other.

In one configuration the trailer comprises at least a pair of electric motors, each motor is mounted to i.e. coupled to one of the first wheel and second wheel, the first wheel and second wheel defining drive wheels such that the electric motor is configured to drive the wheel the motor is mounted to i.e. coupled to, based on a control signal from the controller, and wherein the controller is configured to independently control each of the electric motors independently based on the determined force and orientation of the towing vehicle.

In one configuration each electric motor is an electric hub motor and each electric hub motor configured to drive the wheel it is coupled to in a forward or backward direction.

In one configuration the controller is configured to: determine a magnitude and direction of force from the towing vehicle on the coupling bar at each force sensor control each electric motor independently based on the determined magnitude and direction of the detected force.

In one configuration two force sensors are mounted on the hitch plate to the left of the coupling bar defining a first group of sensors, and two force sensors are mounted on the hitch plate to the right of the coupling bar defining a second group, wherein the controller is configured to: determine a magnitude and direction of force from the towing vehicle as detected at each force sensor in the first group, determine a magnitude and direction of force from the towing vehicle as detected at each force sensor in the second group, determine a resultant magnitude and direction of force at the first group of sensors, determine a resultant magnitude and direction of force at the second group of sensors, control a first electric motor based on the resultant magnitude and direction, and control the second electric motor based on the resultant magnitude and direction, such that each wheel is driven independently.

The controller may be a microcontroller or a microprocessor. In one configuration the controller comprises at least a processor and a memory unit. The controller may be programmed and store executable instructions in the form of software that define functions of the controller.

In one configuration each electric motor is controlled in proportion to the magnitude of the force.

In one configuration the controller is configured to control each electric motor to accelerate or decelerate the wheel the motor is mounted to, based on the magnitude and direction of force detected by the force sensors.

In one configuration the controller is configured to control each electric motor to accelerate or brake the electric motor based on the rate of change of the force detected by the one or more force sensors.

In one configuration the trailer comprises one or more acoustic sensors e.g., ultrasonic sensors. The acoustic sensors are arranged in communication with the controller. The controller may be configured to determine a position of the towing vehicle based on processing an output from each of the one or more acoustic sensors.

In one configuration the at least one optical sensor is mounted on a front side of the receptacle or hitch. The optical sensors may be mounted facing forward. The trailer may comprise additional optical sensors on a rear panel or on the side panels. The trailer may further comprise additional sensors e.g., ultrasonic sensors that may be used for collision detection.

In one configuration the optical sensor and optionally other additional sensors is configured focus on the towing vehicle, and the controller configured to receive signals from the optical sensor and optionally other additional sensors and determine an orientation of the towing vehicle and a distance of the towing vehicle from the trailer.

In one configuration the controller is configured to process signals from the optical sensor and optionally other additional sensors and determine if the towing vehicle is turning relative to the trailer and the controller configured to control the electric motors to cause the trailer to turn in accordance with the turning of the towing vehicle.

In one configuration the trailer comprises at least two optical sensor and optionally other additional sensors mounted on the trailer and spaced apart from each other.

In one configuration at least one optical sensor and optionally other additional sensors is located left of the coupling bar and the other optical sensor and optionally other additional sensors is located right of the coupling bar, such that the coupling bar is located in between the optical sensor and optionally other additional sensors.

In one configuration the optical sensor and optionally other additional sensors comprise cameras. The cameras may be configured to provide wireless signals to the controller. Alternatively, the cameras may be wired to the controller.

In one configuration the controller is configured to: determine a distance of the towing vehicle from the trailer based on the signals from the first optical sensor and optionally other additional sensors, to determine a distance of the towing vehicle from the trailer based on the signals from the second optical sensor and optionally other additional sensors, compare the two distance measures, and; determine if the towing vehicle is turning based on comparing the distance measures and comparing the difference in the distance measures being above a threshold.

In one configuration the towing vehicle is determined to be turning if the controller determines the distance detected by one optical sensor and optionally other additional sensors to be different to the distance detected by the other optical sensor and optionally other additional sensors and wherein the difference is greater than a threshold.

In one configuration the cameras are mounted on the trailer to focus on the towing vehicle, the controller is configured to receive an image stream from the cameras and the controller configured to: recognise the towing vehicle in the image stream by applying an object detection algorithm, determine an orientation of the towing vehicle relative to the trailer based on recognising the towing vehicle in the image stream, wherein the orientation is determined based on comparing the position of the towing vehicle in the image stream from the first camera with the position of the towing vehicle in the image stream from the second camera, control each electric motor independently based at least on the determined orientation of the towing vehicle.

In one configuration the controller is configured to determine if the towing vehicle is turning based on determined orientation of the towing vehicle and a determined distance between the towing vehicle and each camera, the controller configured to control each electric motor to cause the trailer to turn in accordance with the turning of the towing vehicle identified in the controller.

The determined distance between the towing vehicle and the camera is based on the focal length of the camera. The focal length of the camera may be stored in the controller. The controller may use the focal length and the image to determine the distance between the trailer and towing vehicle.

In one configuration the controller is configured to: determine the amount of the towing vehicle that is visible in the images of the image stream from the first camera, determine the amount of the towing vehicle that is visible in the images of the image stream from the second camera, determine if the towing vehicle is turning based on a comparison of the amount of the towing vehicle visible in the image stream from the first camera and the second camera, wherein the controller determines the towing vehicle is turning left if more of the towing vehicle is visible in the images from the first camera than the images from the second camera, and the controller determines the towing vehicle is turning right if more of the towing vehicle is visible in the images from the second camera than the images from the first camera.

In one example configuration the trailer may comprise one or more cameras located on the sides of the trailer. The side cameras may be configured to capture images on either side of the trailer. The controller may be configured to receive the image frames and identify one or more objects or obstacles present to the side of the trailer. Optionally, in one configuration the trailer may comprise cameras on all sides or may comprise cameras all around.

In one configuration the receptacle comprises a battery bay, the battery bay shaped and dimensioned to contain a plurality of batteries.

In one configuration the receptacle comprises any one or more of:
one or more power plugs, the one or more power plugs electrically connected to
the at least one battery to supply power to the power plug,
one or more speakers,
one or more lights to light the internal space of the receptacle,
one or more hooks arranged within the receptacle,
an integrated refrigerator,
an ice maker located within the receptacle,
a waterproof interior lining attached to the inside of the receptacle,
one or more foldable seats,
at least two side panels that are hingeable between an open position and a closed position.

In one configuration the trailer is a semi-trailer.

In one configuration trailer is a recreational trailer.

In one configuration the receptacle comprises a lid, the lid being moveable between an open position and a closed position.

In one configuration the battery bay comprises a plurality of contacts disposed within the battery bay such that the one or more batteries are hot swappable from within the battery bay, and wherein positioning a battery within the battery bay electrically couples the battery to at least the electric motors.

In one configuration the trailer comprises:
a wireless transceiver, the controller in electronic communication with the wireless transceiver, the controller configured to wirelessly tether the trailer to a device with a corresponding wireless transceiver, and the controller configured to control the electric motor when the trailer is wirelessly tethered to the device to cause the trailer to autonomously follow the movement of the device.

In one configuration the controller is configured to control the trailer to autonomously follow the device based on the signal strength of the wireless tether.

In one configuration the controller is configured to activate the at least one optical sensor and optionally other additional sensors, the controller is configured to detect the device, or a person associated with the tethered device based on processing the signals from the optical sensor and optionally other additional sensors, the controller further configured to control the electric motors to cause the trailer to autonomously follow the device or the user associated with the device based on the signals from the optical sensor and optionally other additional sensors.

In one example the controller may use inputs from the one or more cameras and the one or more force sensors to determine the movement i.e., motion of the towing vehicle. The controller is further configured to provide control signals to the motors to control motion of the trailer.

In one configuration the trailer comprises a regenerative braking system, the regenerative braking system configured to harvest power while the wheels are braked or freewheeled, and the regenerative braking system configured to charge the battery using the harvested power.

In one configuration the regenerative braking system comprising a regenerative braking circuit connected between a battery and the electric motor, the regenerative braking circuit configured to route power to the motor when the wheel is being driven and divert power back to charge the battery when the wheels are braked or when the motor is braked.

In one configuration the trailer comprises a GPS module. The controller may be electrically coupled to the GPS module. The controller is configured to determine a location of the trailer via the GPS module. The position of the trailer may be communicated to a user device e.g., a mobile device. The GPS module allows the controller to access a global positioning system and determine the global position of the trailer. The location of the trailer may be presented on a map interface on the user device. For example, the trailer location may be presented on Google Maps on the user device.

According to a second aspect the present disclosure relates to a trailer configured to be towed by a towing vehicle, the trailer comprising:
a chassis,
a hitch to couple the trailer to a towing vehicle,
a receptacle mounted on the chassis and defining a space to hold goods,
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the motor,
a sensor assembly comprising one or more sensors configured to track a force applied by the towing vehicle and/or track movement of the towing vehicle
a controller arranged in the plurality of sensors in the sensor assembly,
the controller electrically coupled to the electric motor and configured to control operation of the electric motor,
wherein the controller further configured to:
   determine an orientation of the towing vehicle based on processing signals from the sensors in the sensor assembly and/or determine a force from the towing vehicle on the trailer based on processing signals from the sensors in the sensor assembly, and
   control the electric motor based on the determined force and/or orientation of the towing vehicle.

In one configuration the sensor assembly comprises one or more force sensors and one or more optical sensor and optionally other additional sensors.

In one configuration the controller is configured to determine a force applied by the towing vehicle based on signals from the one or more force sensors, and the controller further configured to determine an orientation of the signals from the one or more optical sensor and optionally other additional sensors, the controller configured to control the electric motor based on the force and orientation of the towing vehicle.

The trailer as per the second aspect may comprise any one or more features described in accordance with the first aspect.

In one example the controller is configured to use:
inputs from at least two cameras mounted on the front of the trailer,
inputs from one or more optical sensors,
inputs from the force sensors
the controller further configured to use all these inputs to determine the orientation and motion of the towing vehicle, and,
the controller configured to control the electric motors independently to adjust one or more of the speed, orientation, acceleration, deceleration of the trailer.

The trailer as described herein is an electric trailer that comprises electric motors. The electric motors of the trailer are used to reduce the pulling load on the towing vehicle.

In one example the optical sensors are lidar or laser sensors. Additionally, other sensors such as acoustic sensors e.g., ultrasonic sensors can be utilised by the controller. Additionally, the trailer may further comprise additional sensors such as for example non optical sensors e.g., magnetometers, barometers, temperature sensors.

The data from these other sensors may be processed by the controller and may be used to recognise spatial data. Spatial data may include environmental data as well as other objects within the path of the trailer or around the trailer. Spatial data may also include recognising other features such as people, other vehicles, vehicle lights, traffic signals, signal lights, car body shapes, etc. Spatial data may also include estimation of tracks of the same object e.g., the path of a particular object so the controller can determine the possibility of a collision. The cameras e.g., the side cameras and optical sensors and other sensors inputs are used by the controller to determine spatial data. The controller may implement a spatial data recognition sub system that is configured to process the received data frames from the side cameras, optical sensors and other sensors to determine spatial data.

In one example the controller is configured to execute a method controlling a trailer based on the motion of the towing vehicle and/or based on a gesture of the user, the method comprising the steps of:
receiving one or more image frames from at least two cameras,
processing the received image frames to identify one or more gestures performed by the user, wherein the image frames are processed by a gesture classifier that is configured to perform object recognition to identify one or more gestures,
processing the received image frames to identify the motion of the towing vehicle, wherein the image frames are processed by a vehicle follow control classifier that is configured to perform object recognition to identify the motion of the towing vehicle,
determining a path the trailer needs to take in response to the identified gesture or the identified motion of the towing vehicle, wherein the path of the trailer is determined by a dynamic path planning sub system,
generate control signals to control the motion of the trailer, the control signals being generated by a trailer dynamics operation sub system, the control signals being transmitted to the electric motors,
determine if the trailer has reached its final position, and stop the trailer once the trailer has reached its final position.

In one example, the classifiers may be video classifiers that may comprise neural networks e.g., convolution neural networks that may be trained to recognise gestures or the motion of the towing vehicle by applying machine learning algorithms.

In one example the method comprises the additional step of classifying the recognised gesture or recognised motion of the towing vehicle by adding in spatial data from other sensors.

In one example the method comprises the additional step of determining changes in operational aspects of the trailer are required, the change in operational aspects being recognised by a trailer auxiliary operation sub system, and wherein the operational aspects being changes to sub systems of the trailer, and wherein the changes in operational aspects comprises at least one or more of: switching on lights, activating indicator lights.

According to a third aspect the present disclosure relates to a trailer configured to be towed by a towing vehicle comprising:
a chassis,
a hitch to couple the trailer to a towing vehicle,
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the motor,
a sensor assembly comprising one or more sensors configured to sense movement of the towing vehicle,
a controller arranged in communication with the plurality of sensors in the sensor assembly,
the controller electrically coupled to the electric motor and configured to control operation of the electric motor,
wherein the controller further configured to:
   determine a position of the towing vehicle relative to the trailer, based on processing signals from the sensors in the sensor assembly, and
   control the electric motor based on the position of the towing vehicle.

In one configuration the trailer comprises any one or more the features described in reference to the first aspect and/or the features described in reference to the second aspect.

In a fourth aspect the present disclosure relates to a trailer configured to be towed, the trailer comprising:
a chassis,
a hitch to couple the trailer to a towing vehicle,
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the motor,
a sensor assembly comprising two or more types of sensors, one first type of sensor configured to measure a first parameter of the trailer, a second type of sensor configured to measure a second parameter of the trailer,
a controller arranged in communication with the plurality of sensors in the sensor assembly,
the controller electrically coupled to the electric motor and configured to control operation of the electric motor,
wherein the controller further configured to:
   determine a force exerted on the trailer by the towing vehicle based on processing the first parameter measured by the first type of sensor
   determine an orientation of the towing vehicle relative to the trailer based on processing the second parameter measured by the second type of sensor
   control the electric motor based on the determined force and/or orientation of the towing vehicle.

In a further aspect the present disclosure relates to a trailer, the trailer comprising:
a chassis,
a hitch to couple the trailer to a towing vehicle,
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the motor,
the controller configured to control the at least one electric motor based on one or more inputs received via a user device or the controller configured to control the at least one electric motor based on user gestures detected via one or more sensors.

In one configuration the trailer comprises a wireless transceiver, the wireless transceiver arranged in communication with the controller, wherein the wireless transceiver is configured to wirelessly tether or wirelessly couple to a user device.

In one configuration the controller is configured to receive inputs from the user device via the wireless transceiver, the controller configured to control the motor to autonomously drive the trailer based on the inputs from the user device.

In a further aspect the present disclosure relates to a controller for a trailer comprising a chassis, a pair of wheels and a hitch, the controller comprising:
a processor,
a memory unit,
the controller arranged in communication with one or more sensors of a sensor assembly of the trailer,
the controller electrically coupled to at least one electric motor of the trailer and configured to control operation of the at least one electric motor, the at least one electric motor connected to a wheel of the pair of wheels to drive the wheel,
the controller configured to:
   determine an orientation of the towing vehicle based on processing signals from the sensors in the sensor assembly and/or determine a force from the towing vehicle on the trailer based on processing signals from the sensors in the sensor assembly, and
   control the electric motor based on the determined force and/or orientation of the towing vehicle.

In one configuration the sensor assembly comprises one or more force sensors configured to sense a force on the trailer from the towing vehicle, and the sensor assembly further comprising one or more optical sensor and optionally other additional sensors configured to sense an orientation of the towing vehicle relative to the trailer.

In one configuration the controller further configured to: determine a force on the hitch applied by the towing vehicle, based on processing signals received from the one or more force sensors, determine an orientation of the towing vehicle based on processing images received from the optical sensor and optionally other additional sensors, and control the electric motor based on the determined force and orientation

The controller may comprise any of the features or functions described earlier.

The term image frame and image and video frame may be used to define an image captured by the cameras. These may define a single image that may be captured as a single image or may be a frame from a video stream.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

It should be understood that alternative embodiments or configurations may comprise any or all combinations of two or more of the parts, elements or features illustrated, described or referred to in this specification.

As used herein the term ‘and/or’ means ‘and’ or ‘or’, or where the context allows both.

As used herein “(s)” following a noun means the plural and/or singular forms of the noun.

Also, it is noted that at least some embodiments may be described as a method (i.e., process) that is depicted as a flowchart, a flow diagram, a structure diagram, or a block diagram. Although a flowchart may describe the operations as a sequential method, many of the operations can be performed in parallel or concurrently. In addition, the order of the operations may be rearranged. A method (i.e., process) is terminated when its operations are completed.

In this specification, the word “comprising” and its variations, such as “comprises”, has its usual meaning in accordance with international patent practice. That is, the word does not preclude additional or unrecited elements, substances or method steps, in addition to those specifically recited. Thus, the described apparatus, substance or method may have other elements, substances or steps in various embodiments. The term “comprising” (and its grammatical variations) as used herein are used in the inclusive sense of “having” or “including” and not in the sense of “consisting only of”.

The invention (or inventions) as described herein may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

It is to be understood that, if any prior art information is referred to herein, such reference does not constitute an admission that the information forms a part of the common general knowledge in the art, in New Zealand or any other country. Any reference to prior art contained herein is not to be taken as an admission that the information is common general knowledge, unless otherwise indicated

### BRIEF DESCRIPTION OF DRAWINGS

Notwithstanding any other forms which may fall within the scope of the present disclosure, a preferred embodiment will now be described, by way of example only, with reference to the accompanying drawings in which:

FIG. 1 to 3 illustrate various views of one example of a recreational trailer comprising two pairs of wheels attached to it, a hitch, and a receptacle.

FIG. 4 to 6 illustrate various views of a second example of a recreational trailer that comprises a pair of wheels attached to it, a hitch, a receptacle, and a jockey wheel attached to the hitch.

FIG. 7 to 8 illustrate various views of a semi-trailer that comprises a hitch, receptacle, and a plurality of pairs of wheels, wherein at least one pair of wheels are drive wheels.

FIG. 9 illustrates an example of a hitch with multiple force sensors attached between the trailer and the hitch.

FIG. 10 illustrates a top view of the hitch with an example force determined by the controller while the towing vehicle is turning.

FIG. 11 illustrates a top view of the hitch with an example of forces determined by the controller while the towing vehicle is turning.

FIG. 12 illustrates a second example of a hitch that comprises multi axis force sensors, and the hitch being coupled to an underside of the trailer.

FIG. 13 illustrates a front face of the trailer and illustrates the sensor assembly.

FIG. 14 illustrates an optical sensor and optionally other additional sensors sensing the orientation of a towing vehicle relative to the trailer.

FIG. 15 illustrates a schematic diagram of a regenerative braking system.

FIG. 16 illustrates wireless tethering of a user device with the trailer and the optical sensor and optionally other additional sensors focusing on the user device or user once the device is tethered to the device.

FIG. 17 illustrates an example of the autonomous follow of the trailer.

FIG. 18 illustrates a schematic diagram of the controller coupled to various sensors as inputs and coupled to the motor controllers to actuate the motor controllers.

FIG. 19 illustrates a method of controlling a trailer based on the motion of the towing vehicle and/or based on a gesture of the user.

FIG. 20 illustrates an example of a towing vehicle turning as detected by the controller executing one or more classifiers and appropriate control sub systems.

### DETAILED DESCRIPTION

The present disclosure relates to a towed vehicle, in particular a towed trailer. A trailer is a vehicle that is configured to carry goods and is towed by a towing vehicle. Trailers are commonly used to transport goods. One common use of trailers is to transport goods for recreational activities such as camping, kayaking etc. Trailers are also used for commercial goods transport. A common example are semi-trailers. Semi-trailers are used for commercial goods transport. Semi-trailers are towed i.e., pulled by a truck. Semi-trailers may comprise a flatbed or may comprise a receptacle to store goods. The present disclosure relates to a trailer that is comprises one or more electric motors to drive the trailer and a controller that controls operation of the electric motors. The driven trailer further comprises one or more sensors to detect the movement of the towing vehicle. The electric motors may be controlled based on the movement of the towing vehicle i.e., the trailer is driven based on the movement of the towing vehicle.

The trailer is driven by the electric motors to reduce the load required by the towing vehicle. The towing vehicle requires less power due to the driven trailer. This is advantageous for electric towing vehicles as the driven trailer can improve range of the electric towing vehicle. The driven trailer is also advantageous for internal combustion engine towing vehicles as it may improve the fuel efficiency due to reducing the load on the towing vehicle.

In one example the trailer comprises a chassis; a hitch to couple the trailer to a towing vehicle; a receptacle mounted on the chassis and defining a space to hold goods; the hitch may extend outwardly from the receptacle or from the chassis; a wheel assembly coupled to the chassis, the wheel assembly comprising at least a first wheel and a second wheel; at least one electric motor connected to or mounted on at least one wheel, the electric motor configured to drive the at least one wheel; at least one battery, the battery electrically coupled to the electric motor and the electric motor configured to draw power from the battery to drive the motor; a plurality of force sensors mounted on the hitch, at least one optical sensor and optionally other additional sensors mounted on the trailer, a controller arranged in communication with the plurality of force sensors and the at least one optical sensor and optionally other additional sensors, the controller configured to receive and process signals received from the force sensors and the optical sensor and optionally other additional sensors, the controller electrically coupled to the electric motor and configured to control operation of the electric motor, wherein the controller further configured to: determine a force on the hitch applied by the towing vehicle, based on processing signals received from the force sensors, determine an orientation of the towing vehicle based on processing images received from the optical sensor and optionally other additional sensors, control the electric motor based on the determined force and orientation.

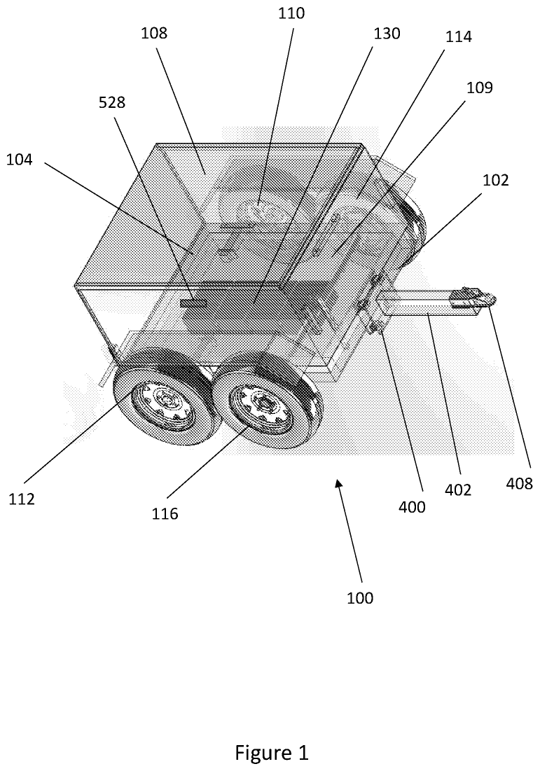

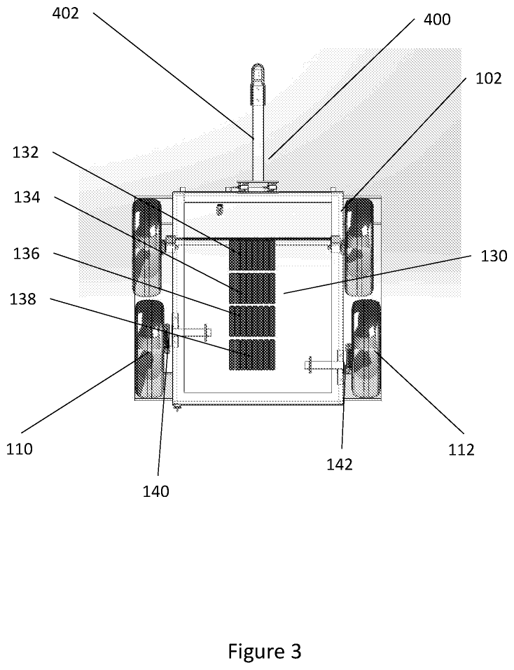

FIGS. 1 to 3 show one example of a trailer 100. The trailer 100 is a driven trailer. The trailer shown in FIGS. 1 to 3 is an example of a recreational trailer i.e., a lifestyle trailer. This lifestyle trailer may be used to transport recreational goods. The trailer 100 comprises a chassis 102 and a receptacle 104. The receptacle 104 is supported in the chassis 102. The receptacle 104 defines a space to hold goods. The chassis 102 forms a frame. In the illustrated form of FIG. 1, the chassis 102 comprises a plurality of frame members that are connected. The frame members may be I beams. The frame members may comprise any other shaped beam. The trailer 100 comprises a hitch 400. The hitch 400 may be coupled to the receptacle 104 or may be coupled to the chassis 102. The hitch 400 comprises at least a coupling bar 402 that is configured to removably fasten the trailer to a towing vehicle. Pulling forces from the towing vehicle are transferred to the trailer via the hitch. The coupling bar 402 includes a coupler 408 at the free end to couple to the towing vehicle.

The receptacle 104 is sized and shaped to retain recreational goods. The receptacle 104 in the illustrated example, is substantially rectangular prism in shape. Alternatively, the receptacle 104 may be any other suitable shape e.g., cube or cylindrical or any other suitable shape. The receptacle 104 comprises a lid 108. The lid 108 being moveable between an open position and a closed position. The lid 108 is pivotable between an open and closed position. Alternatively, the lid 108 may slide horizontally between an open and closed position. In some examples, the receptacle may have at least one open surface, for example an open top surface, an open side surface, an open front surface, and/or an open rear surface.

In one example form, the trailer may comprise an open topped chassis (for example when the receptacle has an open top surface). The trailer may be shaped and dimensioned to retain and transport watercraft such as for example jet skis, boats, kayaks, or other such recreational craft.

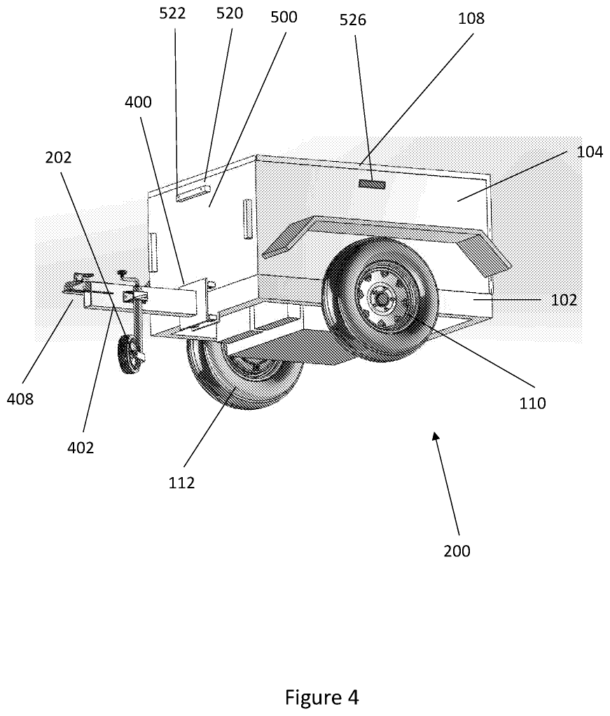

The receptacle 104 comprises a plurality of walls. The walls and the lid 108 define the space within the receptacle 104. In one example at one or more of the walls may also pivot between an open and closed position to expose the base 109. The receptacle 104 comprises a battery bay 130 that is shaped and dimensioned to receive a plurality of batteries. The battery bay 130 may be disposed in the base 109. The battery bay 130 may be a channel or a recess to store batteries. The base 109 may comprise a false floor that covers the battery bay. The battery bay 130 may comprise one or more electrical contacts. The electrical contacts (not illustrated) may be exposed and positioned to electrically couple to a battery positioned in the battery bay 130. FIG. 4 illustrates an example of the trailer that comprises four batteries 132, 134, 136 and 138 disposed in the battery bay 130. The batteries 132-138 supply power to the electric motors.

The batteries 132-138 may be hot swappable. The batteries may be configured to insert and remove from the battery bay while the trailer and controller are activated i.e., hot swappable. Alternatively, the batteries may be removed or swapped while the controller and motors are switched off. The trailer may comprise a switch that electrically connect or disconnect the batteries i.e., to allow switching ON or OFF the controller and motors. The trailer 100 comprises appropriate circuitry to allow hot swapping of batteries.

The trailer 100 comprises a plurality of wheels to propel the trailer 100. The example shown in FIGS. 1 to 3 the trailer 100 comprises two pairs of wheels. The trailer comprises a first pair of wheels 110, 112, and a second pair of wheels 114, 116. The wheels 114, 116 are mounted on a common axle as these are not drive wheels. The trailer 100 comprises two mudguards. One mudguard is attached to the chassis or are attached the receptacle 104. The first pair of wheels 110, 112 (the rear wheels) in the illustrated example are drive wheels. The second pair of wheels 114, 116 (the front wheels) are free spinning wheels. The wheels each include a tyre on the wheel. The drive wheels 110, 112 are directly fixed to electric motors via a coupling shaft or other suitable coupling. Alternatively, in one example configuration the second pair of wheels 114, 116 may comprise the drive wheels. In this alternative configuration the first pair of wheels may be free spinning wheels and the second pair of wheels 114, 116 may be the drive wheels. In a further alternative configuration both pairs of wheels may comprise drive wheels, and both pairs of wheels may be driven by electric motors.

The trailer comprises at least one electric motor connected to or mounted on at least one wheel; the electric motor configured to drive the at least one wheel.

In one example the trailer 100 comprises a pair of electric motors 140, 142. Each electric motor is mounted to i.e., coupled to each wheel of the drive wheels 110, 112. One electric motor is mounted to i.e., coupled to one wheel. Mounted to means directly attached to or directly coupled to. Each electric motor 140, 142 is an electric hub motor. Each hub motor 140, 142 is mounted directly to one wheel of the drive wheels 110, 112. Each hub motor may be independently controlled such that each wheel can be independently driven. For example, each wheel may be independently actuated. The hub motors 140, 142 are advantageous because the motors drive the wheels 110, 112. This reduces load on the towing vehicle.

In another example the trailer may comprise at least one electric motor that is connected to the drive wheels. The at least one electric motor may be connected via a connection assembly e.g., a differential or a gearbox or other suitable mechanical connection assembly. The connection assembly is adapted to allow the electric motor to drive the wheels 110, 112 or drive one wheel.

The trailer 100 further comprises a controller 150 that is in communication with one or more sensors on the trailer. The controller 150 is configured to process signals from the sensors. The controller 150 (i.e., central controller) is further configured to control operation of the electric motors. The controller 150 (i.e., central controller) is mounted in the receptacle or on an underside of the trailer or in the battery bay 130. The controller 150 comprises one or more hardware processors and a memory unit. The memory unit may be a computer readable medium that may store executable instructions. The executable instructions may be software modules, sub systems or engines. The memory unit may also include an operating system and other essential software components.

The controller 150 may be a microcontroller or a microprocessor or a combination of multiple microprocessors or a combination of integrated circuits or an FPGA or other suitable device that is capable of being programmed and execute software applications or software programs. The controller 150 can include programming instructions for detection of input conditions and control of output conditions. The programming instructions can be stored in the memory unit of the controller 150. The programming instructions can correspond to the methods, processes and functions described herein. The programming instructions can be executed by one or more hardware processors of the controller 150. The programming instructions can be implemented in C, C++, JAVA, or any other suitable programming languages. Some or all the portions of the programming instructions can be implemented in application specific circuitry such as ASICs and FPGAs. The controller 150 may comprise one or more software sub systems or software engines or software modules that may be configured to perform various functions. Each software sub system or engine may be programmed to perform a specific function. The various software components may be defined as executable code that is stored in the memory unit of the controller 150 and executed by the processor of the controller 150.

The trailer 100 further comprises one or more motor controllers. In one example the trailer 100 comprises a separate motor controller associated with each hub motor. The central controller 150 is configured to provide control signals to the motor controllers. The motor controller in turn actuates the hub motors. In this disclosure reference to the central controller controlling the hub motors may be implemented as described above, i.e., the central controller transmits signals to the motor controllers and the motor controllers actuating the hub motors. Alternatively, the central controller may directly send control signals to the hub motors to control operation of the hub motors.

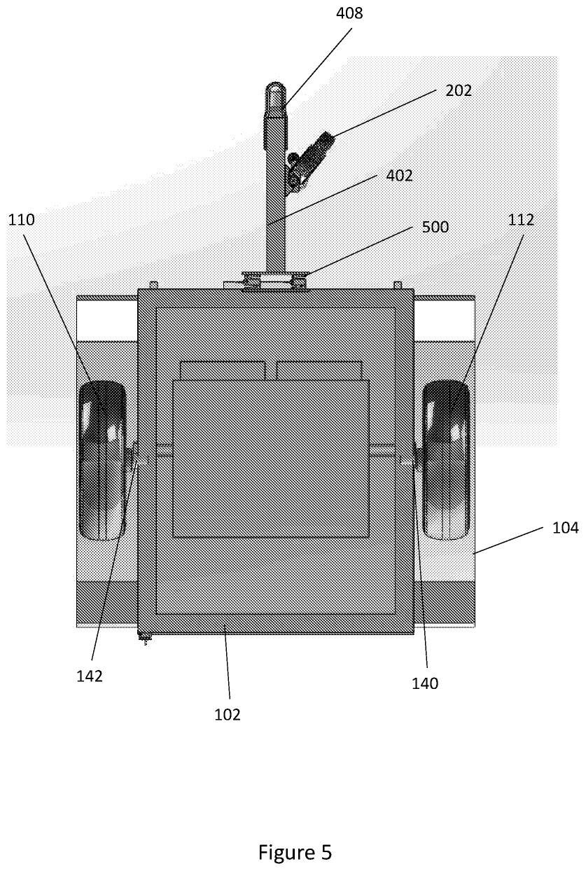

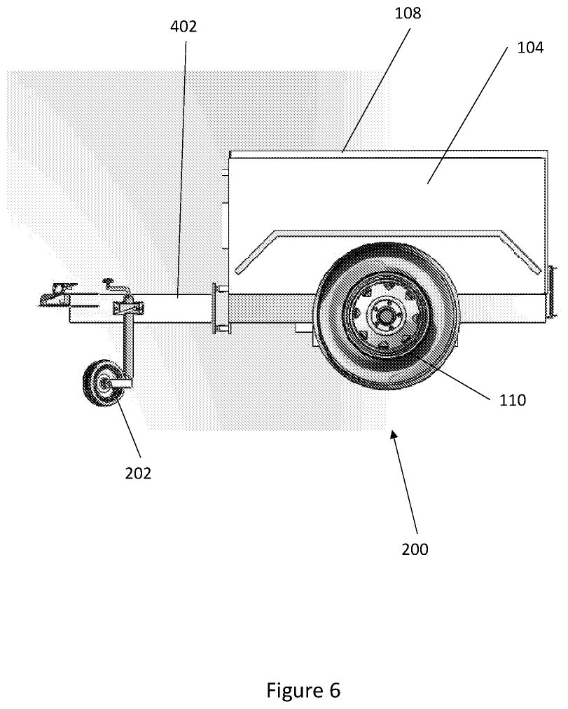

FIGS. 4 to 6 illustrate a second example of the trailer 200. The trailer 200 is also a recreational trailer. The trailer 200 is suited for transporting recreational goods. The example illustrates in FIGS. 4 to 6 has a similar structure to the trailer shown in FIGS. 1 to 3. The trailer 200 has all the same features as trailer 100. The trailer 200 comprises the hitch 400. One difference is trailer 200 has one pair of drive wheels 110, 112 and a third jockey wheel 202. The jockey wheel 202 is coupled to the coupling bar 402 of the hitch 400. The jockey wheel 202 comprises a mounting that is bolted to the coupling bar 402. The jockey wheel further includes a free spinning wheel 202. The wheel 202 is not driven and can freely spin allowing the trailer mobility.

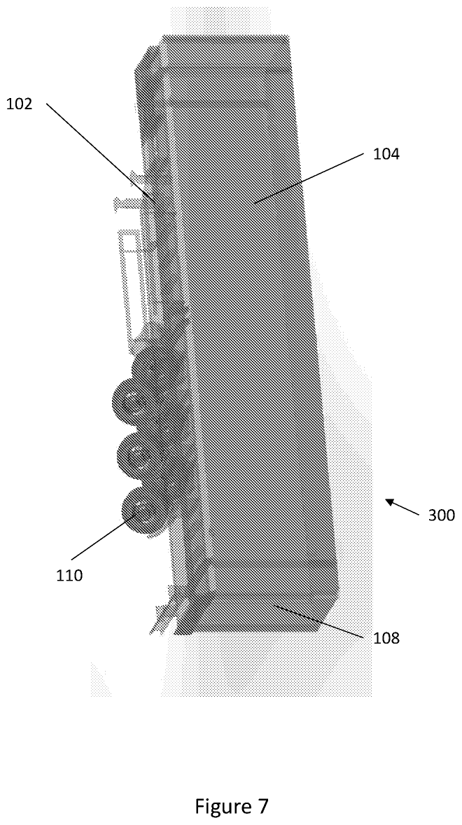

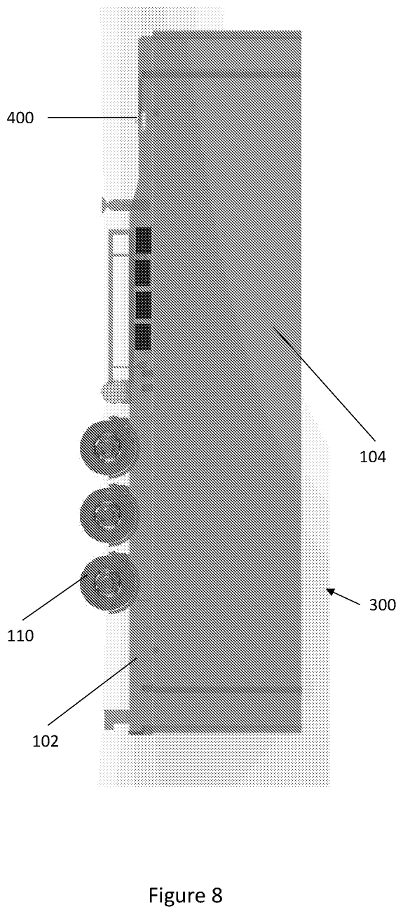

FIGS. 7 to 8 illustrate a third example of a trailer 300. The trailer 300 is a commercial trailer. The commercial trailer may be a semi-trailer. The illustrated trailer in FIGS. 7 to 8 is a semi-trailer that is a flatbed semi-trailer with a container (i.e., receptacle) on the flat bed. The container may be integrated into the flat bed. The trailer 300 may be any other suitable type of semi-trailer e.g., a step deck type, lowboy type, reefer type, tanker type etc. The trailer 300 comprises the same features as the trailer 100. The trailer 300 is larger in size than the recreational trailer 100, 200. The trailer 300 comprises a chassis 102, a receptacle 104 and a plurality of wheels attached to the chassis. The trailer also comprises a hitch 400 that couples the trailer 300 to a towing vehicle. The towing vehicle is a truck.

The receptacle 104 of trailer 300 is shaped and dimensioned to hold goods. The receptacle 104 may be an enclosed container. Alternatively, the receptacle 104 may be an open space with a base e.g., a flatbed. Receptacle defines a structure and space that is used to retain goods. The receptacle 104 may comprise an openable door 108.

The trailer 300 comprises a plurality of pairs of wheels. The wheels are mounted to axles, and the axles are coupled to the chassis. The illustrated example the trailer 300 comprises three pairs of wheels. At least one pair of wheels is a pair of drive wheels 110, 112. The trailer 300 comprises at least two electric hub motors 140, 142. Each hub 140, 142 motor is mounted to i.e., coupled to a single wheel of the pair of drive wheels. The hub motors 140, 142 are configured to drive the drive wheels. The trailer 300 also comprises a central controller and motor controllers as described earlier. The motor controllers and hub motors used for trailer 300 may be larger than the recreational trailer 100 to drive the larger commercial trailer.

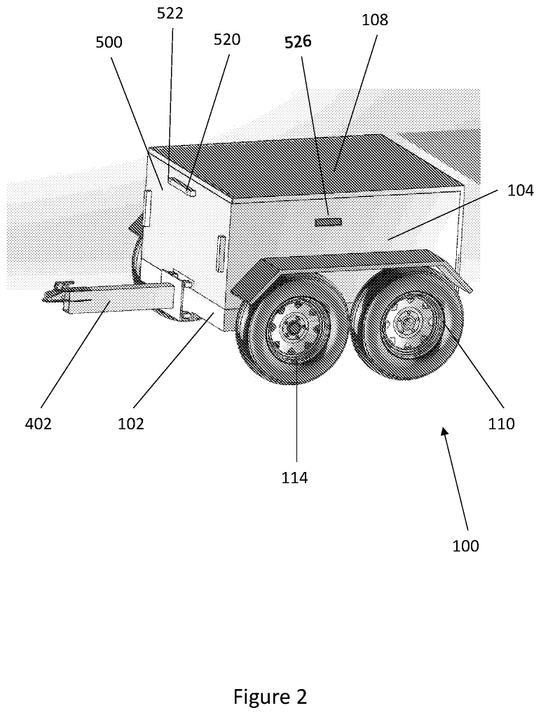

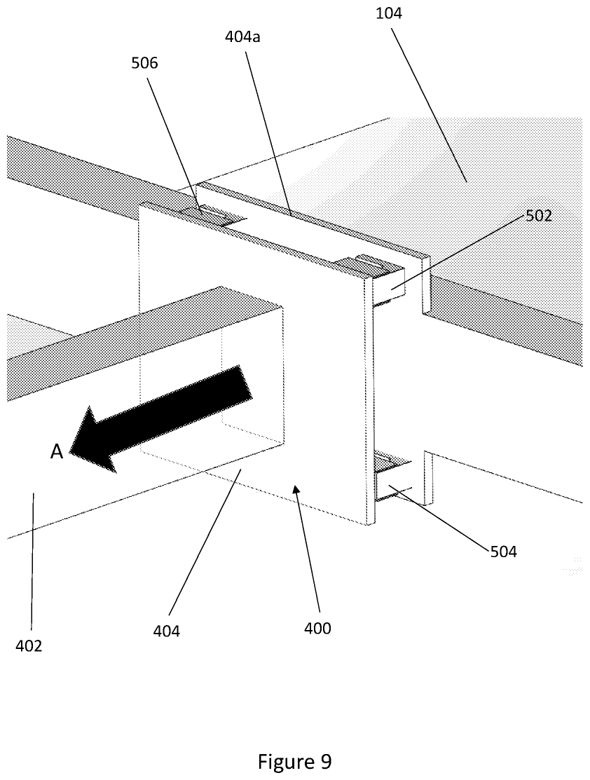

The trailer 100, 200, 300 each comprise a hitch 400. Referring to FIGS. 9 to 11 illustrate one example of a hitch 400. The hitch 400 as illustrated may be part of a trailer 100, 200, 300. The hitch 400 is configured to link the trailer to a towing vehicle. The hitch 400 comprises a hitch plate 404 and a coupling bar 402 that extends outwardly from the hitch plate 404. The hitch plate 404 is coupled to the trailer. In the illustrated example, the hitch plate 404 is coupled to the chassis, as shown in FIG. 9 and as shown in FIGS. 2 and 4. The hitch 400 may be coupled i.e., mounted to the receptacle. The hitch 400 as shown in FIGS. 9 to 11 may be used in any of the trailers 100, 200, 300.

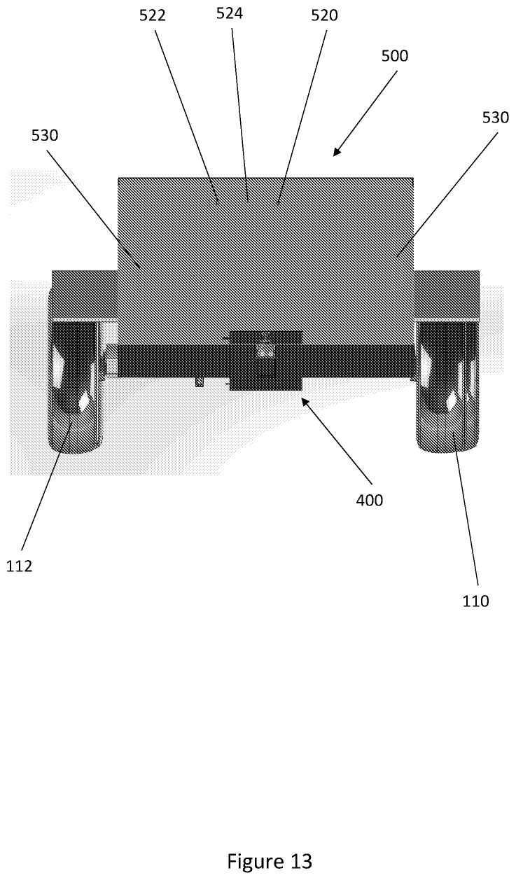

The trailer comprises a sensor assembly 500. FIG. 13 illustrates an example of the sensor assembly 500 disposed on trailer 100. The sensor assembly 500 may be disposed on any one of the trailers described herein. The sensor assembly 500 comprises one or more types of sensors. The sensors are in communication with the controller 150 (i.e., central controller). The controller 150 is configured to determine a force on the hitch from the towing vehicle and/or determine the orientation of the towing vehicle based on the signals from the sensors in the sensor assembly. The one or more types of sensors in the sensor assembly are configured to track parameters related to the movement of the towing vehicle. The sensor assembly 500 may comprise one or more force sensors that are mounted on the trailer and are configured to measure a force on the trailer from the towing vehicle. The sensor assembly 500 may comprise one or more optical sensor and optionally other additional sensors configured to track motion and/or orientation of the towing vehicle relative to the trailer.

The hitch may comprise sensors that may be integral with the hitch. Alternatively, the sensors may be mounted to the hitch. In a further alternative form the sensors may be mounted between the hitch plate and the chassis. Some sensors may be mounted on other portions of the trailer.

The controller 150 is further configured to control the hub motors 140, 142 to drive the trailer based on the force from the towing vehicle and/or orientation of the of the towing vehicle. The trailer may be accelerated or decelerated based on the detected orientation of the towing vehicle. The trailer is accelerated or decelerated based on the power applied to the hub motors. The central controller is configured to provide a control signal that defines the amount of acceleration or deceleration. The motor controllers are configured to translate the acceleration or deceleration to an appropriate power signal. Acceleration may be caused by increasing the power applied. Deceleration may be caused by braking the hub motors.

In a further example the central controller 150 may directly control the hub motors 140, 142. The central controller 150 may directly transmit a control signal to increase power (i.e., accelerate) the hub motor or reduce power or brake the hub motor (i.e., to decelerate). The central controller 150 may comprise appropriate circuitry to communicate with the hub motors directly.

The controller 150 is configured to control each wheel independently by independently controlling the hub motor associated with the wheel. More specifically, the controller 150 is configured to independently control each drive wheel from the pair of drive wheels. The motor controllers may be configured to receive separate control signals, from the central controller 150 to independently control the drive wheels. Separate control of the drive wheels allows a trailer to assist in turning, as the towing vehicle turns. The trailer 100, 200, 300 may be turned some degree e.g., partially turned by driving each drive wheel in opposing directions to each other. For example, one wheel is driven forward, and the other wheel is driven in reverse in order to turn the trailer.

In one example a trailer may comprise multiple pairs of drive wheels. For example, the trailer 300 may comprise two pairs of drive wheels. The drive wheels on one side of the trailer may be driven in one direction, and the drive wheels on the other side are driven in an opposing direction i.e., reverse. The wheels are driven by controlling the hub motors 140, 142 appropriately to either drive the wheels forward or backward. In an alternative form, the controller may be configured to turn the trailer by driving only one wheel or wheels on one side of the trailer faster than the wheel or wheels on the other side. Driving the wheel(s) on one side faster may cause the trailer to turn. The turning rate is based on the power applied to the hub motors. The controller 150 is configured to determine the turning rate based on the determined orientation of the towing vehicle.

In one example the trailer comprises one or more force sensors and at least one optical sensor and optionally other additional sensors. The one or more force sensors are configured to measure a force on the trailer from the towing vehicle. The one or more force sensors mounted on the hitch. The at least one optical sensor mounted on the trailer. The controller is arranged in communication with the plurality of force sensors and the at least one optical sensor. The controller configured to receive and process signals received from the force sensors and the optical sensor. The controller electrically coupled to the electric motor and configured to control operation of the electric motor. The controller further configured to determine a force on the hitch applied by the towing vehicle, based on processing signals received from the one or more force sensors. The controller further configured to determine an orientation of the towing vehicle based on processing images received from the optical sensor. The controller is configured to control the electric motor based on the determined force and orientation.

The sensor assembly 500 comprises at least one or more force sensors and one or more optical sensor and optionally other additional sensors. The force sensors may be load cells, strain gauges or other suitable sensors that are configured to sense one dimensional or multi-dimensional forces. The optical sensors may comprise a camera. The camera may comprise a stereo depth camera. Alternatively, the camera may comprise time of flight camera. The trailer may comprise one or more cameras on each side. The trailer may also comprise a camera on the rear face.

Alternatively, the optical sensors may comprise LiDAR or lasers to determine distance and orientation of the towing vehicle 1 in relation to the trailer. Optionally the sensor assembly 500 may comprise acoustic sensors e.g., ultrasonic sensors, or Radar or other sensors that are used to determine the motion and orientation of the towing vehicle. The trailer may comprise a combination of cameras and other optical sensors such as Lidar, ultrasonic sensors or other sensors.

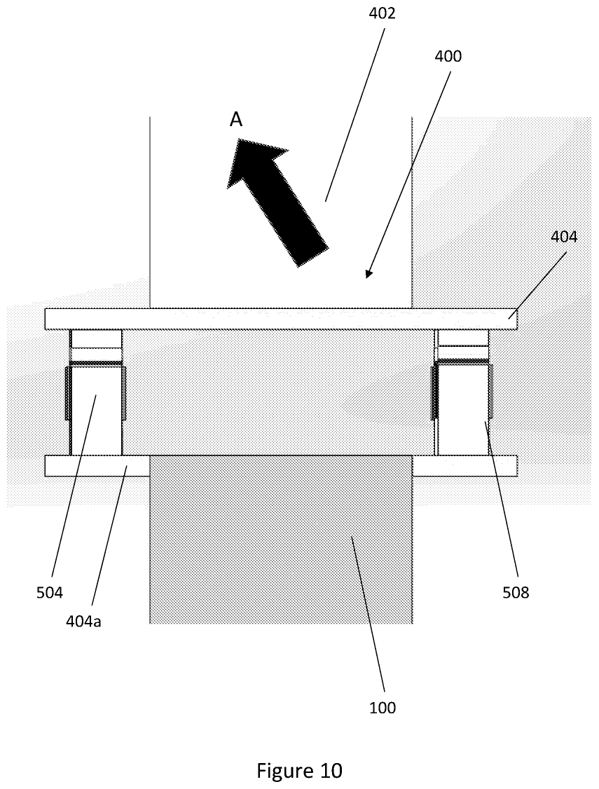

In one example the trailer 100, 200, 300 comprises a sensor assembly 500. The sensor assembly 500 comprises a plurality of force sensors 502, 504, 506, 508. In one example the force sensors 502, 504, 506, 508 are load cells. In a further example the load cells are strain gauges. The load cells 502, 504, 506, 508 are S shaped load cells. The load cells 502, 504, 506, 508 are mounted on the hitch 400. As shown in FIGS. 9 and 10 the hitch plate 404 is attached to the receptacle 104 or chassis 102 via the load cells 502-508. As shown in FIGS. 9 to 11 the load cells 502-508 are sandwiched between the hitch plate 404 and either of the receptacle 104 or chassis 102. The load cells (i.e., force sensors) 502-506 are configured sense the force on the coupling bar 402, caused by the towing vehicle. Each force sensor 502-508 is mounted at or adjacent a corner of the hitch plate 402. The example hitch plate is square shaped and the force sensors are mounted equidistant to each other. The hitch may comprise two hitch plates 404, 404a. The load cells may be sandwiched between these two plates. The second hitch plate 404a may couple to the chassis or receptacle of the trailer.

In one example the force sensors 502-508 are single axis load sensors that are configured to measure a force in one dimension i.e., along one axis. Alternatively, the force sensors may sense multi axis forces. The force sensors 502-508 are linear force sensors. The force sensors 502-508 generate a signal indicative of a force applied by the towing vehicle on the coupling bar. The signals are transmitted to the controller 150, and the controller 150 is configured to process these signals and determine a force applied to the coupling bar. The controller 150 is configured to determine a magnitude and direction of force from the towing vehicle on the coupling bar based on processing the signals from the force sensors 502-508.

The controller 150 may be configured to determine a resultant force based on the force sensed at each force sensor 502-508. The controller 150 may be further configured to determine at least one or more of a magnitude and direction of the resultant force, wherein the resultant force is representative of a force applied to the trailer by the towing vehicle.

The controller 150 is configured to independently control each electric motor (i.e., each hub motor) independently based on the determined magnitude and direction of the detected force. The controller 150 may determine a resultant force based on the signals received from all four force sensors 502-508.

The controller 150 may be configured to filter out impulse forces detected by the force sensors. For example, the controller 150 may filter out forces that are detected for less than a time threshold e.g., if a force is detected by the force sensors 502-508 for less than 1 second or for less than 0.5 second or any other threshold, then the controller 150 may ignore this force. Such a short application of force is treated as an impulse and could represent bumps in the ground. In order to prevent false triggering or false control of the motors, the controller may filter out such impulses measured by the force sensors. The filter may be a time filter. The controller may also apply a magnitude filter and filter out forces that are below a threshold.

FIG. 9 illustrates arrow A that is indicative of the force from the towing vehicle. The arrow A is representative of the resultant force that is determined by the controller 150. The arrow A is representative of the force vector that is calculated by the controller 150 based on the readings from the force sensors 502-508. The load cells 502-508 output an electrical signal e.g., a voltage or a current that is indicative of a force vector. The controller 150 is configured to process these signals and determine a force vector detected by each load cell 502-508. The controller 150 is further programmed to determine a resultant force A that is detected by resolving the individual force vectors detected by the load cells 502-508. The force vector A is representative of the pulling force from the towing vehicle as the towing vehicle tows the trailer. The direction of the force A may be reversed if the towing vehicle is reversing and pushing the trailer.

The force vector A may be determined by the controller based on the force measurements from each force sensor. The force vector A represents a resultant force vector due to a force from the towing vehicle. The controller may resolve i.e., determine a three-dimensional force vector that is representative of the forces from the towing vehicle upon the trailer. For example, force vector A may represent a resultant force vector.

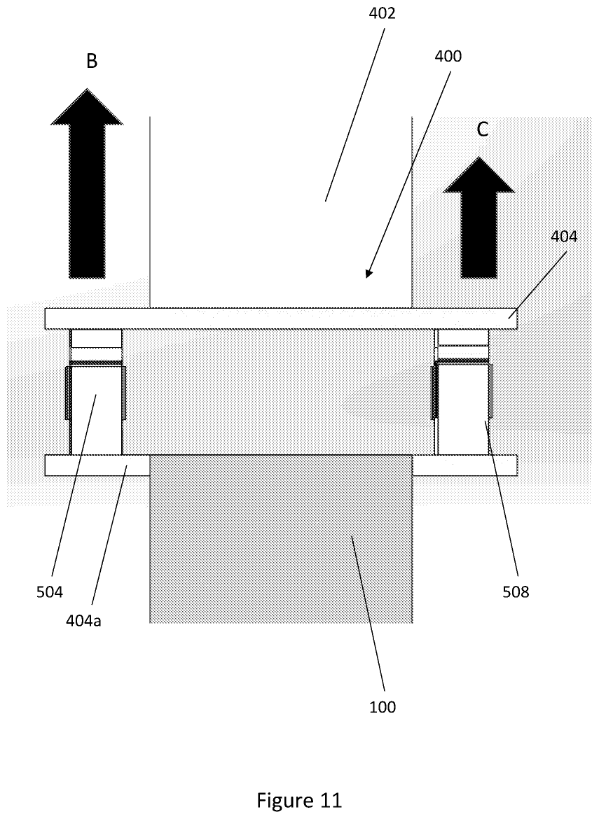

As shown in FIG. 9 and FIG. 11 two force sensors 502, 504 are mounted on the hitch plate 404 to the left of the coupling bar 402 defining a first group of force sensors. FIG. 11 shows an underside of the hitch 400. Two force sensors 506, 508 are mounted on the hitch plate 404 to the right of the coupling bar 402 defining a second group. The controller 150 is configured to determine a magnitude and direction of force from the towing vehicle as detected at each force sensor in the first group. The controller 150 is configured to determine a magnitude and direction of force from the towing vehicle as detected at each force sensor in the second group. The controller is further configured to determine a resultant magnitude and direction of force at the first group of sensors 502, 504. This resultant force vector is represented by arrow B in FIG. 11. The controller determines a resultant magnitude and direction of force at the second group of sensors 506, 508. This force vector is represented by the force vector C in FIG. 11. The controller 150 is configured to control each of hub motors 140, 142 independently based on the magnitude and direction of the detected force.

In one example implementation the controller 150 is configured to compare the magnitude of force sensed at the first group of force sensors 502, 504 with the magnitude of force sensed at the second group of force sensors 506, 508. The force vector B and the force vector C are compared by the controller 150. If the force is larger in the first group, then the first drive wheel 110 is driven with a larger power than the second wheel 112. Similarly, the second wheel 112 is driven with a larger power if the second group of force sensors detect a larger force. The larger force in one group of sensors is indicative of the towing vehicle turning. The drive wheels are independently turned to cause the trailer to turn in a similar direction with the towing vehicle. This type of control of the electric motors to drive the drive wheels based on the magnitude and direction of the towing force, allows the trailer 100, 200, 300 to be driven to follow the towing vehicle.

FIG. 10 illustrates another example of the force vector resolved by the controller 150. In this example the controller 150 may resolve a force vector A that is representative of the force from the towing vehicle, similar to as shown in FIG. 9. In one example implementation the controller 150 is configured to determine the direction and magnitude of the force, as shown in FIG. 10. Force vector A, as shown in FIG. 10 points in an angled direction. The vector A in FIG. 10 represents the towing vehicle is turning to the left. Hence, the force vector direction is toward the left. The controller 150 is configured to resolve the force vector based on readings from the force sensors 502-506. The controller 150 is configured to control each motor independently. In the example case of FIG. 10 as the towing vehicle is turning to the left, the right motor i.e., motor 142 is provided with more power than the left motor i.e., motor 140. This causes the right wheel to be driven faster than the left wheel to facilitate turning of the trailer. The control is changed if the towing vehicle is turning to the right. To turn the trailer one motor may be switched off to facilitate a sharp turn. The controller 150 is configured to control the power to each motor and hence the speed of each wheel based on the magnitude and direction of the force vector determined from the force sensor 502-508 outputs.

The controller 150 may be configured to control a first drive wheel and second drive wheel independently based on the detected force. Each electric motor 140, 142 may be controlled in proportion to the magnitude of the force. The controller 150 is further configured to control each electric hub motor 140, 142 to accelerate or decelerate the associated wheel based on the magnitude and direction of the force detected by the force sensors 502-508. The controller 150 may be configured to control each electric hub motor 140, 142 to accelerate or brake based on the rate of change of the force detected by the force sensors 502-508.

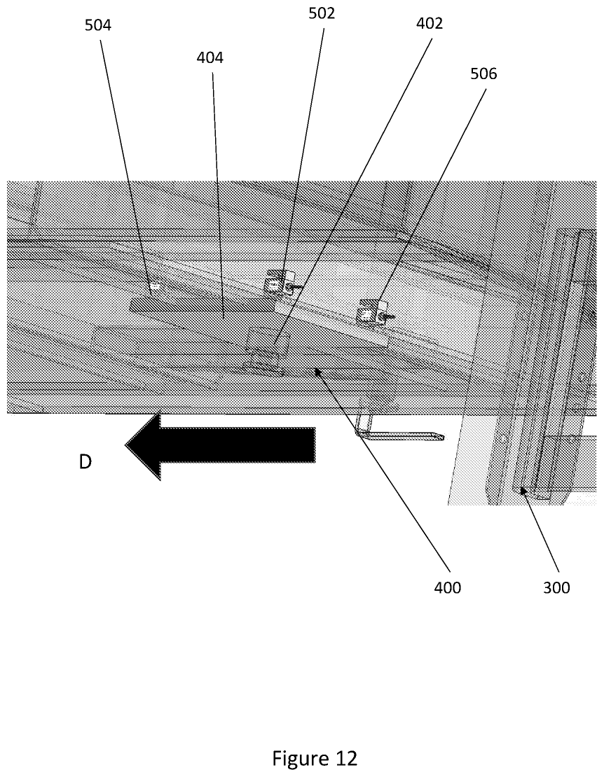

FIG. 12 illustrates an example of a hitch 400 that is mounted on an underside of the trailer. The hitch 400 as shown in FIG. 12 is used with trailer 300, i.e., a semi-trailer type trailer since the hitch 400 is normally on the underside of such a trailer. The hitch 400 as shown in FIG. 12 comprises a coupling bar 402 and a hitch plate 404. In one example the trailer 100, 200, 300 comprises four load cells 512, 514, 516, 518 that are sandwiched between the receptacle 104 and the hitch plate 404. The load cells 512-518 may comprise multi axis load cells that are configured to sense forces in multiple axes. In the example of FIG. 12 the load cells are 3 axis force sensors. This output of the 3 axis load sensors 512-518 is processed by the controller 150 to determine the magnitude and direction of the force on the trailer 300 from the towing vehicle. FIG. 12 illustrates a resultant force vector D that is determined by the controller based on processing signals received from the three axis load cells 512-518.

The controller 150 is configured to control the hub motors based on the detected magnitude and direction of the force. The controller 150 is configured to control power supplied to the motors is in proportion to the magnitude of the force. The motors are controlled in the direction as the detected force. This allows the trailer to be driven and follow the towing vehicle and reduce the load on the towing vehicle. The 3 axis load cells operate in shear and the controller 150 is programmed to resolve the magnitude and direction of the force based on the output of the load cells. The controller 150 is configured to determine the magnitude and direction of the force on the trailer from the towing vehicle (i.e., a truck).

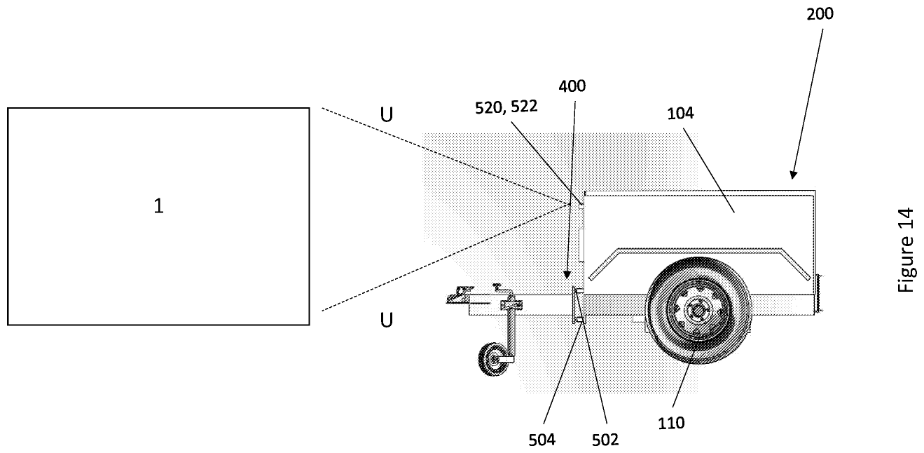

The trailer comprises at least one optical sensor 520. The trailer 100 may also comprise other additional sensors. The optical sensor 520 forms part of the sensor assembly 500. The optical sensor is mounted on a front side of the receptacle 104 or the hitch 400. The sensor assembly 500 comprises a plurality of optical sensors. In one example, as shown in FIG. 13, the sensor assembly 500 comprises two optical sensors 520, 522. The optical sensors 520, 522 are spaced from each other. The sensors are disposed in a mount 524. In one example the optical sensor 520 is positioned on the trailer 100, 200, 300 in such a way that the optical sensor focusses on the towing vehicle. The optical sensor 520 is configured focus on the towing vehicle, and the controller configured to receive signals from the optical sensor and determine at least an orientation of the towing vehicle. The controller 150 is further configured to determine a distance of the towing vehicle from the trailer 100, 200, 300. FIG. 14 illustrates an example of the optical sensors 520, 522 positioned to focus on the towing vehicle 1. The optical sensors 520, 522 are positioned to detect at least one outer edge and an upper edge of the towing vehicle. FIG. 14 shows an example view field U of the optical sensor 520. The optical sensor detects the position of the outer edge and upper edge of the towing vehicle. At least one optical sensor 520 is located to the left of the coupling bar 402 and the other optical sensor 522 is located right of the coupling bar 402. The coupling bar 402 is located between the optical sensors 520, 522, as shown in FIG. 13.

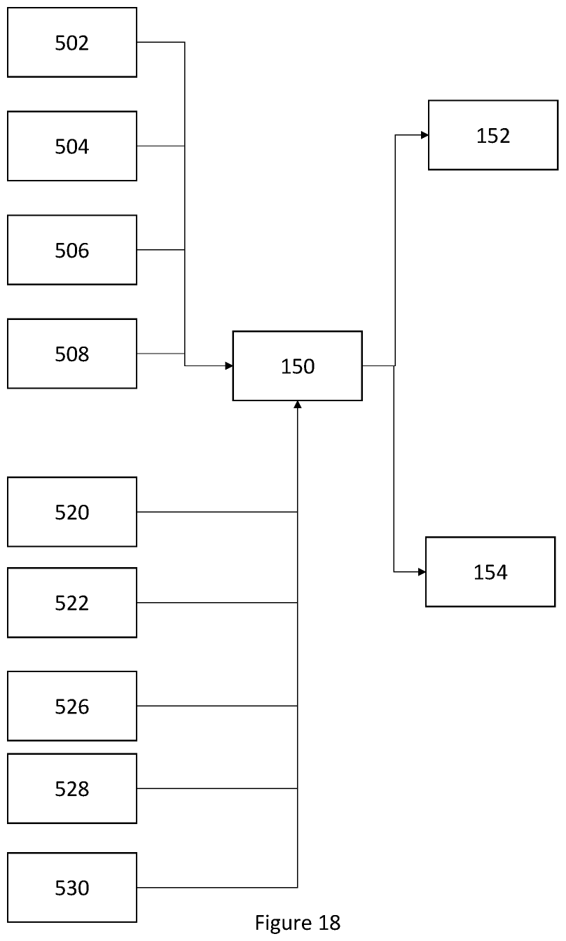

In one example the trailer may comprise side cameras and may optionally also comprise a rear camera. The side cameras may be mounted on the sides. FIG. 2 illustrates a side camera 526 and FIG. 1 shows a further side camera on the opposing side to the side that has camera 526. The side cameras 526, 528 are in communication with the controller 150, as shown in FIG. 18. The controller 150 may process images from the side cameras 526, 528 to identify one or more objects.

In one example, the trailer 100, 200, 300 may comprise multiple optical sensors. The trailer may contain optical sensors on the sides and rear of the trailer. The trailer 100, 200, 300 may further comprise additional sensors on the sides. The trailer may comprise any suitable combination of cameras, force sensors and other sensors such as Lidar, lasers, ultrasonic sensors. Optionally the trailer may also comprise mechanical proximity sensors e.g., limit switches etc.

The controller 150 is configured to receive signals from the optical sensor and optionally other additional sensors and process these received signals. The controller 150 is configured to determine and orientation of the towing vehicle and a distance of the towing vehicle from the trailer 100, 200, 300. The controller 150 is configured to process the signals from the optical sensors 520, 522 and determine if the towing vehicle 1 is turning relative to the trailer. Optionally, the controller may also use inputs from the other sensors e.g., Lidar in combination with the cameras and optical sensors to determine the orientation of the towing vehicle.

The controller 150 is further configured to control the electric hub motors 140, 142 (or in the case of trailer 300 control all the hub motors that are engaged to the drive wheels) to cause the trailer to turn or partially turn in accordance with the turning of the towing vehicle detected based on the optical sensor 520, 522 signals. The trailer may be turned by individually controlling the hub motors to drive the wheels at different speeds or in different directions. This independent control of the drive wheels, by controlling the associated hub motors will assist the towing vehicle to pull the trailer around corners. This control of the wheels reduces the load on the towing vehicle.

In one example the controller 150 is configured to determine if the towing vehicle is turning based on comparing the distance between the towing vehicle and trailer as detected at optical sensor and optionally other additional sensors. In one example the controller 150 receives signals from the optical sensors 520, 522. The controller 150 is configured to determine a distance of the towing vehicle from the trailer based on the signals from the first optical sensor 520. The controller 150 is further configured to determine a distance of the towing vehicle from the trailer based on the signals from the second optical sensor 522. The controller is the configured to compare the two distance measures and determine if the towing vehicle is turning based on comparing the distance measures. Alternatively, the controller 150 is configured to determine if the towing vehicle is turning based on the difference in the distance measures being above a threshold. The controller 150 determines the towing vehicle is turning if the controller 150 determines the distance detected by one optical sensor to be different to the distance detected by the other optical sensor. The controller 150 checks if the difference is greater than a threshold. The threshold may be stored in the memory of the controller 150.

In the illustrated example trailers 100, 200, 300 the optical sensors 520, 522 are cameras. The cameras 520, 522 capture images or an image stream (i.e., a video stream). The controller 150 is configured to receive the video stream (or individual images) and process these images to determine an orientation of the towing vehicle relative to the trailer. The controller 150 determines if the towing vehicle is turning. Optionally the controller 150 may further determine the distance of the towing vehicle from the trailer 100, 200, 300. The controller 150 may determine distance based on the signals from the optical sensors 520, 522. In one example, each camera may comprise time of flight depth camera. In another example, each camera may comprise a depth stereo camera. In a further example the trailer may comprise one of each type of camera.

In one example the controller 150 is programmed to apply an object recognition algorithm to the image stream (or images) received from the cameras 520, 522. The object recognition allows the controller 150 to detect the towing vehicle from images. The controller 150 is configured to process the image stream and recognise the towing vehicle in the image stream by applying an object detection algorithm. The controller 150 may be trained via machine learning to recognise the towing vehicle. Additionally, the controller 150 may be trained to recognise various other object types.

The controller is configured to determine an orientation of the towing vehicle relative to the trailer based on recognising the towing vehicle in the image stream from the cameras 520, 522. The controller 150 is configured to recognise the orientation of the towing vehicle is determined based on comparing the position of the towing vehicle in the image stream from the first camera 520 with the position of the towing vehicle in the image stream from the second camera 522. The controller 150 is configured to control each electric motor independently based at least on the determined orientation of the towing vehicle. The controller 150 is configured to determine if the towing vehicle is turning based on determined orientation of the towing vehicle and a determined distance between the towing vehicle and each camera. The controller 150 is configured to control each electric motor to cause the trailer to turn in accordance with the turning of the towing vehicle identified in the controller. Each hub motor 140, 142 is independently controlled to turn the trailer in accordance with the determined turning of the towing vehicle. Controlling the hub motors independently assists the towing vehicle in pulling the trailer around turns.

The distance between the towing vehicle and each camera 520, 522 is based on the focal length of the camera. The focal length is used as a reference measure to calculate the distance between the towing vehicle and the camera. In one example the controller 150 determines the orientation of the towing vehicle based on the comparing the detected towing vehicle in images captured from both cameras. The controller 150 is configured to determine the amount of the towing vehicle that is visible in the images of the image stream from the first camera 520. The controller 150 is configured to determine the amount of the towing vehicle that is visible in the images of the image stream from the second camera 522. The controller 150 is configured to determine if the towing vehicle is turning based on a comparison of the amount of the towing vehicle visible in the image stream from the first camera 520 and the second camera 522. The controller determines the towing vehicle is turning left if more of the towing vehicle is visible in the images from the first camera 520 than the images from the second camera 522 and the controller 150 determines the towing vehicle is turning right if more of the towing vehicle is visible in the images from the second camera 522 than the images from the first camera 520. The controller 150 further controls the electric hub motors 140, 142 based on the amount the towing vehicle is turning.

In another example the controller 150 may determine distance based on the distance detected by the depth stereo camera. Optionally, the controller 150 may determine distance based on the output from the time-of-flight camera. The controller may be programmed to determine the towing vehicle and the distance to the towing vehicle by processing the camera output.

The hub motors 140, 142 being controlled based on the detected force and the orientation of the towing vehicle reduces the load on the towing vehicle. The driven trailer reduces the power draw on the towing vehicle. This is particularly advantageous when the towing vehicle is an electric vehicle. Electric vehicles are often more power limited than internal combustion engine cars. Electric vehicles also often have a smaller power supply due to a finite number of batteries. A driven trailer that includes force sensors and optical sensors to drive a trailer around turns improves efficiency of electric towing vehicles. The load due to the trailer is reduced since the hub motors are controlled to drive the trailer. Further the same advantages apply to an internal combustion engine type towing vehicle. The driven trailer 100, 200, 300 as described herein is advantageous as it improves the fuel efficiency for internal combustion type towing vehicles.

In one example the sensor assembly comprises one or more ultrasonic sensors 530 on a front panel and rear panel. The one or more ultrasonic sensors 530 are arranged in communication with the controller 150. The one or more ultrasonic sensors 530 can be used for tracking distance and collision detection. The ultrasonic sensors can detect the distance between the front or back of the trailer and another object based on the time of flight of the ultrasonic signal. The controller is configured to determine the distance between the trailer and another object based on the signals. The controller may activate an audible or visual alarm. The controller 150 may also raise an alarm on the towing vehicle or transmit an alarm to a user device e.g., a user mobile phone. Alternatively, the ultrasonic sensors 530 may be laser sensors that may be used to determine distance.

In one configuration, the controller is configured to determine obstacles, objects and/or people to avoid collision. Collision avoidance may be performed using the optical sensor and optionally other additional sensors. Collision avoidance may also be determined by the controller by processing signals from the ultrasonic sensors. The controller may also be configured to determine collision avoidance based on processing outputs of the camera or cameras. In an example the side cameras may be used in combination with the front cameras and other sensors to perform object detection to avoid collisions.

FIG. 18 shows a schematic of the controller 150 in communication with the sensors and in communication with the motors. The controller receives signals from the force sensors 502-508, the optical sensors 520, 522 and the ultrasonic sensors 530. The controller 150 is configured to receive sensor signals and process these signals. The controller 150 is configured to actuate the one or more hub motors 140, 142. In the illustrated example the central controller 150 transmits actuation signals to the motor controllers 152, 154 associated with the hub motors 140, 142. The motor controller 152, 154 control the hub motors based on the control signals i.e., actuation signals from the central controller.

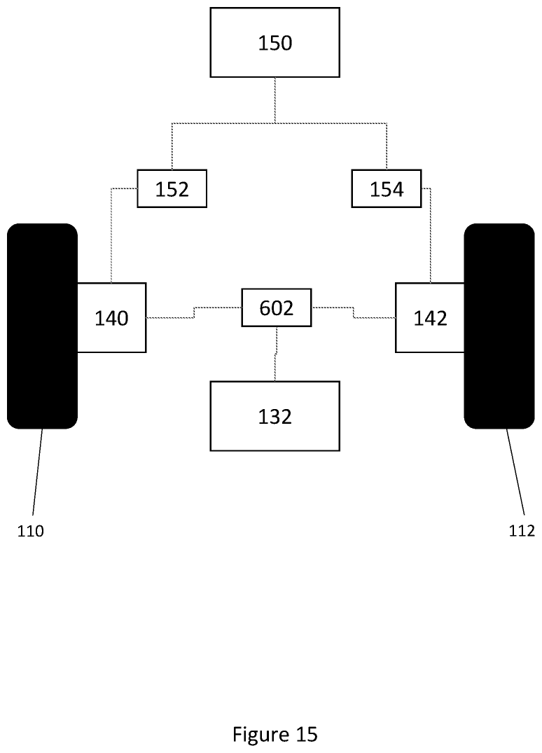

The trailer 100, 200, 300 further comprises a regenerative braking system. FIG. 15 illustrates a schematic of an example regenerative braking system 600. As shown in FIG. 15 the battery 132 is in electrical communication to each electric hub motor 140 142 to supply power to the electric hub motors 140, 142. Each electric hub motor 140, 142 is associated with a drive wheel to drive the wheel. The central controller 150 is connected to a motor controller associated with each hub motor. The first motor controller 152, is associated with the first hub motor to control power and voltage to the hub motor 140. The second motor controller 152 is associated with the second hub motor. Power is drawn from the battery 132 to drive the wheels forward by providing power to the hub motors. The regenerative braking system 600 is configured to harvest energy when the trailer is braked or freewheeled to charge the battery 132. As the trailer is braked electrically, energy is routed back to the battery to charge the battery 132. The system 600 comprises a regenerative braking circuit 602 that is interconnected between the battery and the motors 140, 142. The circuit 602 comprises appropriate circuit components that are configured to divert power to run the motor normally to drive the wheels and harvest power when the motor is braked. During braking and/or freewheeling the motors 140, 142 can function as a generator. The power harvested during braking is used to charge the battery 132.

The recreational trailer 100, 200 comprises one or more accessories. In one example the accessories may comprise any one or more of: one or more power plugs, the one or more power plugs electrically connected to the at least one battery to supply power to the power plug, one or more speakers, one or more lights to light the internal space of the receptacle, an integrated refrigerator, an ice maker located within the receptacle, a waterproof interior lining attached to the inside of the receptacle, one or more foldable seats, at least two side panels that are hingeable between an open position and a closed position. The panels may comprise latches or fasteners to hold the panels in the closed position. The trailer may comprise one or more USB interfaces. The USB interfaces may allow connection to the controller to extract data. The USB ports may allow transmission of control signals e.g., to moderate power to the electric motors. The USB interfaces may also allow other devices e.g., phones or music players to connect to the trailer. The trailer may comprise an integrated GPS unit that may allow location tracking of the trailer.

The trailer 100 may further comprise indicator lights to indicate turning. The trailer 100 may further comprise additional display lights. The display lights may be on the body of the trailer. The display lights may be used to provide messages to a user. The display lights may extend across the body in any suitable configuration. The display lights may indicate when the lid is open or when the trailer is stopped or moving. The display lights may be activated if there is an imminent collision or an object is detected in the path of the trailer. The display lights can be used to provide various information to users.

The trailer may comprise an air compressor as an accessory. The air compressor may be connectable to the batteries within the trailer to power the air compressor. The air compressor allows inflation of watercraft.

In one example configuration the trailer may comprise one or more rails mounted either on the interior or exterior of the trailer. Optionally the rails may be positioned on the interior and exterior. The rails may be mounted on an interior and/or exterior of the receptacle. Optionally the rails may be mounted to the chassis. The rails may allow mounting of various items to the trailer. The trailer may also comprise one or more hooks to mount various items.

The internal of the recreational trailer 100, 200 may comprise fittings to hold various recreational objects. For example, the trailer 100, 200 may comprise hooks or fasteners to hold kayaks or surfboards or other watercraft. The recreational trailer 100, 200 may also comprise USB ports and/or auxiliary ports. The USB ports or auxiliary ports allow a phone or stereo to be plugged in to play music through the speakers. The speakers may be integrated into one or of the side panels. The speakers are also electrically coupled to the battery by a suitable electrical connection to power the speakers through the batteries in the battery bay 130. The trailer may further comprise a speaker controller and interfacing circuitry that couples the speakers to the batteries. The speaker controller and interfacing circuitry controls operation and power to the speakers to drive the speakers. The speakers may further comprise a wireless communication module e.g., a Bluetooth module. A user can wirelessly connect with the speakers and play music via the wireless communication module.

The trailer 100, 200, 300 further comprises a wireless transceiver 700. The wireless transceiver 700 may comprise a transmitter and a receiver. In one example the wireless transceiver 700 may be integrated into the upper panel of the trailer. Alternatively, the transceiver 700 may be mounted on an outer surface of the trailer. In a further alternative the transceiver 700 may be integrated with the central controller 150. The transceiver 700 is arranged in electronic communication with the central controller 150.

The wireless transceiver 700 is configured to wirelessly tether to a user device 10. The user device 10 may be a mobile device e.g., a smartphone or a tablet or other suitable mobile device that comprises wireless communication capabilities and a corresponding wireless transceiver. The transceiver 700 can wirelessly tether to the user device 10. The controller 150 is configured to wirelessly tether to the device 10. The wireless transceiver functions as a wireless communication module. The wireless transceiver is configured to communicate with the user device 10 via a suitable wireless communication protocol such as for example Bluetooth, Zigbee or any other wireless communication protocol.

Once tethered the controller 150 is configured to control the trailer to autonomously follow the movement of the device 10. The controller 150 is configured to control the electric motors to follow the device 10 based on the signal strength of the wireless tether. The controller 150 is configured to control speed of the trailer to maintain a signal strength within a specific range. Additionally, the controller 150 is configured to activate the at least one optical sensor 520, 522. Preferably both optical sensors 520, 522 are activated. The controller 150 is configured to detect the device 10 or a person associated with the device 10. The controller 150 is configured to control the electric motor 140, 142 to cause the trailer to autonomously follow the device or the user associated with the device 10.

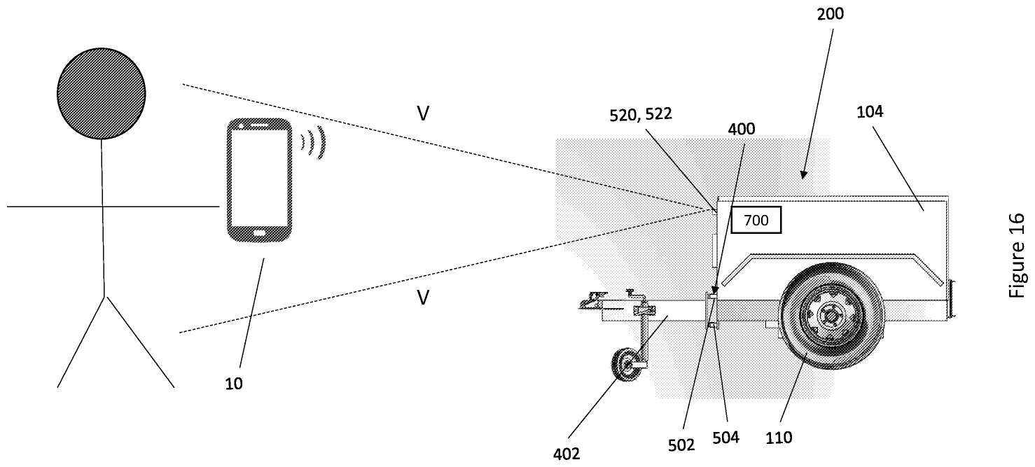

FIG. 16 illustrates an example of the wireless transceiver 700 wirelessly tethered to the device. The optical sensors 520, 522 are cameras. The cameras 520, 522 are activated. The controller 150 is configured to receive images from the cameras. The view cone V illustrates the cameras focused on the user device or the user. The user 1 or the device 10 is identified in the image stream (or in multiple images) by applying an object recognition algorithm. The controller 150 is configured to determine the distance between the device 10 (or user 1) and the trailer. The controller 150 is configured to control the hub motors 140, 142 to control motion of the trailer to maintain a predetermined or pre-set distance between the device 10 (or user).

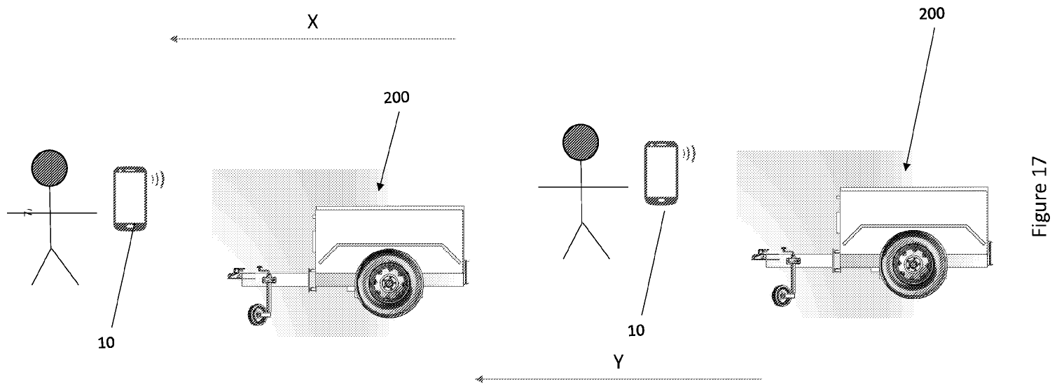

The user may be able to communicate with the controller 150 via the mobile device 10. The user may be able to define a specific follow distance. FIG. 17 illustrates an example of the autonomous follow feature. As shown in FIG. 17 the user 1 has moved along the direction of arrow X a certain distance. The trailer 200 is controlled to autonomously follow the user based on the signal strength of the wireless tether between the transceiver 700 and the mobile device 10, and the user recognised in the camera image stream. The trailer is moved the same distance the user is moved in the direction of arrow Y.

In one example configuration the user can establish a wireless connection with the trailer via the transceiver 700. The user device 10 may present a control interface on the device 10. The control interface would allow the device 10 to function as a remote control. The device 10 can be used to control the trailer 100, 200, 300 manually via manual inputs into the device 10. For example, a user may remotely drive the trailer by transmitting control signals wirelessly. The trailer would follow the instructions and drive autonomously based on the inputs to the device 10 from the user. The trailer is configured to utilise the sensors e.g., the camera or cameras to continually perform collision avoidance. The trailer would utilise some or all sensors e.g., cameras and ultrasonic sensors. The controller is configured to perform collision avoidance based on the sensor signals. The controller may stop the trailer if it detects an object or person or obstacle within a defined proximity to the trailer. The controller executes a suitable software algorithm for collision avoidance. In one example the controller may utilise object recognition on the images captured by the camera or cameras. The object recognition method is configured to detect and identify objects within the images. The controller is configured to determine the distance to the detected and identified objects. If the controller detects the object is too close, the controller may stop the trailer by stopping power to the electric motors.

Autonomous follow is advantageous because trailer can be moved easily without any towing vehicle. This is specifically useful in carparks to park a trailer. This is particularly useful for large semitrailers 300 and fleet management. Trailer 300 can be manually controlled via the device 10 or may be controlled to autonomously follow the user allow the user to easily manoeuvre the trailer 300 around a parking lot. The autonomous follow or remote control of the trailer also allows a user to easily manoeuvre a trailer without the need for a towing vehicle or manual exertion. Further for the recreational trailer 100, 200 the autonomous follow is advantageous because it allows the user to bring the trailer into areas which may not be accessible to the towing vehicle. For example, the trailer 100, 200 may follow the user (or the user may manually control the trailer) to a location near a lake or a river. The goods in the trailer can be brought to a specific recreational location e.g., a camping location or a water sport location etc.

The trailer 100, 200, 300 may be configured to auto hitch i.e., auto couple to a towing vehicle. The trailer 100, 200, 300 would auto hitch to an appropriate towing vehicle. The controller may be configured to identify the towing vehicle, its position and the type, based on applying an object recognition algorithm to images captured by the camera (or cameras). The controller may be configured to identify one or more gestures performed by a user. The controller may recognise gestures by processing images captured by the camera(s). In one example the controller 150 is configured to determine the type of gesture based on a machine learning algorithm. The controller may be trained with appropriate training data that includes various gestures. Alternatively, the controller may apply a suitable AI algorithm to identify gestures.

In another example the controller 150 may determine the type of gesture by comparing it with a database of known gestures. The database being stored in a memory unit associated with the controller. The controller 150 is further configured to identify the type of gesture.

If an auto hitch gesture is recognised by the controller 150, the controller 150 is configured to activate and control the electric motors to drive the trailer to position it adjacent the towing vehicle. The controller 150 is configured to control the electric motors to move the trailer such that the hitch couples to the corresponding coupler on the towing vehicle, automatically. This automatic coupling is performed in response to recognising an appropriate coupling gesture. The controller 150 may transmit a signal indicating confirmation of auto coupling or failure of auto coupling to the mobile device 10 (i.e., user device). Confirmation or failure of auto coupling may be displayed as a message or indication on the mobile device. An audible alarm may sound that represents either successful or unsuccessful auto coupling.

In one example, a specific visual message, corresponding to a successful auto coupling is presented on the user device. A specific visual message corresponding to unsuccessful auto coupling may be presented if the auto coupling process is not successful. The trailer may be stopped by the controller if the auto coupling is unsuccessful. The trailer 100, 200, 300 may comprise one or more indicators e.g., lights positioned on the trailer to indicate successful auto coupling or indicate unsuccessful auto coupling. The indicators may be configured to present other visual messages e.g., low battery warnings or proximity warnings. The trailer may further comprise speakers that present an audible message corresponding to coupling or other messages e.g., low battery warnings or proximity warnings.

In one configuration the trailer comprises a GPS module. The controller may be electrically coupled to the GPS module. The controller is configured to determine a location of the trailer via the GPS module. The position of the trailer may be communicated to a user device e.g., a mobile device. The GPS module allows the controller to access a global positioning system and determine the global position of the trailer. The location of the trailer may be presented on a map interface on the user device. For example, the trailer location may be presented on Google Maps on the user device.

The trailer may comprise a computer vision-based control system. The control system may comprise a combination of computer vision i.e., based on image processing and mechanical sensing from the force sensors. The cameras may be mounted on the trailer and may be configured to capture images of the towing vehicle (e.g., a truck or utility vehicle). The controller 150 may be configured to receive the captured images from the cameras and configured to perform object recognition on the images to detect the towing vehicle within the captured images. The controller 150 may be further configured to determine the motion of the towing vehicle and control the electric motors based on the detected position of the towing vehicle. The electric motors 140, 142 are controlled by the controller 150 to change speed, stop or turn the trailer 100 based on the detected motion of the towing vehicle 1. The vision based control may be implemented using optical sensor and optionally other additional sensors as an alternate to cameras. Cameras may be the optical sensors. In a further alternate form, the trailer may comprise cameras and optical sensors and optionally other additional sensors, and the controller may be configured to a combination of all the sensors to determine the motion of the towing vehicle. The controller is configured to control the motors to adjust the motion e.g., path or trajectory or speed or braking of the trailer.

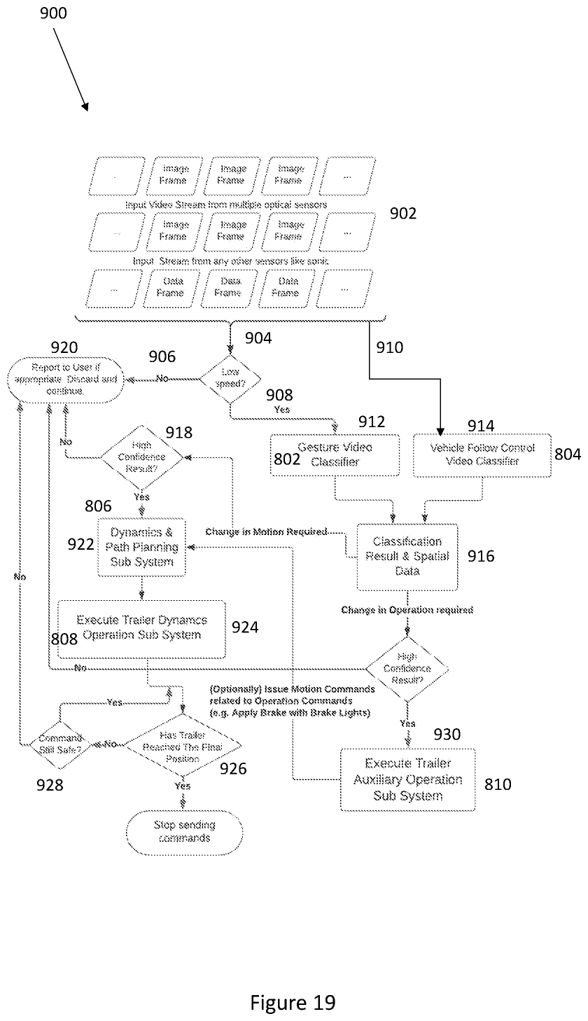

FIG. 19 illustrates a method 900 of controlling a trailer based on the motion of the towing vehicle and/or based on a gesture of the user. The motion of the towing vehicle may be captured by cameras and/or optical sensor and optionally other additional sensors. The captured images or video frame and/or the signals from the optical sensors may be processed to detect a motion of the towing vehicle 1. The trailer 100 may be controlled based on the detected motion of the towing vehicle 1. The method 900 may also be applied to detect one or more gestures from a user. The user may be detected based on images or video captured by the cameras and/or based on detected optical signals from the optical sensors. The gestures may be identified and the trailer 100 may be controlled based on the identified gestures. The method 900 of controlling the trailer is executed by the controller 150. The method 900 may be defined as executable instructions.

The method 900 comprises step 902. Step 902 comprises receiving multiple images (i.e., image frames) from the camera. Each image frame may be a still image or a frame in a video captured by the cameras. Step 902 further comprises capturing data frames from the optical sensors. Step 904 comprises checking if the towing vehicle is moving at low speeds. If the towing vehicle is not moving at low speed, then an error may be reported as per step 906. If a low speed is detected then the images are passed to a gesture video classifier 802, at step 908. Steps 904 to 908 may be optional. At step 910 the image frames are passed to a vehicle follow control video classifier 804. Optionally at step 910 in addition to the images frames, the data frames may also be passed to the video follow control classifier 804. A video classifier is a software system i.e., software module that takes several sequential video frames and uses machine learning models (like a deep learning model like a Convolutional Neural Network) to then detect objects within each frame, and attempt to correlate their direction of travel (e.g. the same object moving left) or change in state (e.g. a brake light turning on or off). These neural networks are trained to recognise different things by supplying specific training data like. images, videos and other data, related to each use case that the video classifier is trying to detect or understand.

The models are trained using lots of related sample footage and images with varying lighting conditions, weather conditions, and lots of variety of target objects and scenes in which the category of tracked objects are aimed to be identifiable.

The gesture video classifier 802 is a specially trained video classifier deep neural network (or other machine learning system) that is trained to recognise instances of a human user making broad and clear gestures using their hands and arms in images, videos and other data. These gestures can be a “Hand Wave” or a “Come here”—for example the following gestures appear as:
Hand Wave: where a person (the user) extends their arm, faces the palm of their hand upright and away from their own face, then rotates/tilts their hand/palm from left to right about 45 degrees each side, repeatedly.
Come Here: where a person (the user) extends their arm, faces the palm of their hand toward their own face, then brings their hand toward their head.

Other gestures are contemplated, and the gesture video classifier 802 may be trained to identify other gestures. The gesture classifier's 802 machine Learning model may be trained using typical training techniques to provide reliable and accurate recognition in a broad range of scene and environmental conditions, such as providing sufficient sample images, videos and other data of a diverse range of people acting out these gestures, fully and partially in frame, with varied lighting conditions, varied weather conditions and background scenes, the training set may contain images, videos and other data of “not gestures” to train the Neural network. The model is trained with sufficient sample images, videos and other data that it is able to reliably recognise the different classes of gesture and able to classify them into a discrete command with a confidence score that describes how clearly the gesture was tracked and detected by the model(s). Several models may be used in combination either series or parallel to understand different criteria that may help the classifier 802 provide more accurate detections—for example a Human Pose Estimation model, a Human Hand model, a Human Person model.

These may be video based classifiers and models that are able to track the temporal relationships of objects that appear in sequential frames from the same video footage or video stream from the cameras. This can be done by analysing the changes in a human's arm position and/or orientation over several frames—using techniques like Long Short-Term Memory (LSTM) networks and Kalman filters. These processing techniques can be used to model the temporal dependencies and estimate the direction more accurately.

The trailer 100 may comprise a pair of cameras (as described earlier). The cameras may be 2 stereo cameras (2 cameras set a fixed distance apart). The models may be trained to use depth estimation techniques and machine learning models to estimate how far an object, person or a person's hand might be from the camera and also how an object, person, or person's hand moves through 3D space.

The vehicle follow control video classifier 804 is a specially trained classifier that is intended to follow the vehicle in front of it (the lead vehicle i.e., the towing vehicle 1). The lead vehicle may be the towing vehicle 1 e.g., a small or large truck or may be a common passenger vehicle intended for public roads. The Vehicle Follow Control Classifier (VFCC) 804, is like the Gesture control classifier 802, but instead looks for lead-vehicle (towing vehicle) related attributes in a video, this might be things such as: brake lights, license plates, the general shape of the rear of a typical lead vehicle for each class of common vehicles like a passenger car.

The VFCC 804 may further be trained to look for changes in each of these attributes to use as control signals to the trailer. For example, the lead-vehicle (i.e., towing vehicle 1) may blink its right indicator light. The VFCC 804 would detect this attribute change (amber or turn indicator light on, then light off) and this information would be fed into the trailer controller and the trailer's turn right signal would start blinking on and off while the LV's turn signal is also still active. Similarly for brake lights, and reversing lights.

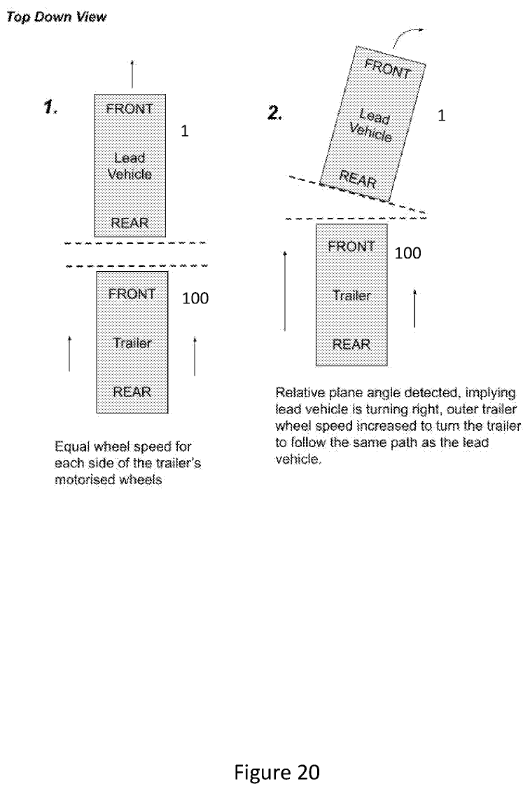

These light states may feed into the trailer's braking, turning/steering, or acceleration control decisions as an additional attribute in addition to the control signal being read from the dynamic hitch. Additionally, the vehicle gesture classifier 804 may use Deep Neural Networks and other algorithms to estimate the plane of the lead vehicle rear “face”. Using continuous evaluation of the angle of the lead vehicle relative to the trailer's front “face” further control information can be deduced about which direction the trailer may be turning next. FIG. 20 illustrates an example of this.

Referring to FIG. 20, an example of the towing vehicle turning is shown as detected by the VFCC 804. The image labelled 1 illustrates the towing vehicle 1 (i.e., lead vehicle) moving straight ahead. Equal wheel speed for each side of the trailer is detected. The angle detected from the camera images is equal. The image labelled 2 shows the lead vehicle 1 turning to the right (when viewed from the top). The relative plane angle that is detected implying the lead vehicle is turning right. The outer trailer wheel speed is increased, and if necessary, brakes applied independently to each wheel, to turn the trailer (as denoted by the larger arrow), to follow the same path as the lead vehicle 1. The illustrated example shows the motors are driven at different speeds.

Returning to describing the method 900. Step 912 comprises processing the image frames using the gesture video classifier 802 to identify one or more gestures being performed by the user. Step 914 comprises processing the image frames using the video follow control video classifier 804. The gesture classifier and the video follow control classifiers 804 may both process the received image frames in parallel. If a user is gesturing then the video follow control classifier (VFCC) would not detect any lead vehicle (i.e., towing vehicle) and the gesture classifier would detect gestures. In the case where the trailer 100 is being pulled by the towing vehicle, the gesture classifier 802 would not detect a gesture and the VFCC 804 would detect the motion of the towing vehicle and appropriately control the electric motors to change the speed of the wheels.

Step 916 comprises generating the classification results based on the processing of the image frames. Spatial data is also introduced at step 916. Spatial data may be for example (inferred point cloud, or point cloud provided by sensors like LIDAR). Spatial data may be provided by the data frames from the optical sensors. Step 918 comprises checking the outputs are high confidence. If the results are not high confidence an error may be reported at step 920 or the results of the classification may be discarded. The classification step 916 may determine a change in motion of the trailer is required either based on a gesture or based on detected motion of the towing vehicle.

The method progresses to step 922 if the results of classification are high confidence. At step 922 a Dynamic path planning sub system 806 (DPPSS) is configured to process the classification and spatial data to determine the path the trailer 100 should follow. is a system of software algorithms that may include neural networks or deep neural networks. The system analyses the input gesture or vehicle control and determines a path which the trailer can follow that is free from obstructions or incompatible surfaces like water or very steep terrain. The system classifies, using sensor data over several frames as well as optical sensor and optionally other additional sensors data like LiDAR or LADAR or video or image data over several frames, objects and surfaces that would obstruct the trailer's path to the final position. The safety of the commands being executed to move the trailer are continuously evaluated while traversing the path, any obstructions or loss of sufficient sensor or camera input due to weather or lens obstructions like mud, would terminate the path traversal.

The DPPSS 806 may be configured to attempt to infer a sufficiently represented bounding shape or shapes for each detected obstruction that was close to its real-world dimensions and location relative to the trailer's cameras. Using 3D geometry mathematics, the bounding geometry and 3D spatial data (inferred point cloud, or point cloud provided by sensors like LIDAR) would be added to a virtual 3D scene that maps sufficiently close to 1:1 to the real-world in terms of locations, dimensions and sizes to allow reliable and safe navigation. A path finding algorithm like “Dijkstra A*” may be used by the DPPSS 806 to form a virtual path made of line segments or curves that can be safely followed from the current position to the target position that navigates around any obstructions detected from the sensors. The target position may be determined by the gesture logic, for example, it may be the estimated physical position of the person who is gesturing, or it may be an object or another input signal like the wireless tether device (a personal phone, or other Bluetooth device paired with the trailer). The target position may also be the estimated new position of the vehicle in front of the trailer which it is following.

Once the path is determined the method progresses to 924. Step 924 comprises executing a trailer dynamics operation sub system 808. This sub system may be a software engine or software module. The Trailer Dynamics Operation Sub-system (TDOSS) 808 may be configured to control motion related functions like acceleration of each wheel independently, independent braking using typical disk or drum brakes of each wheel, independent braking using regenerative resistance of each electric wheel motor independently and switching each wheel to regenerative energy reclamation. The appropriate control motion is determined at step 924.

Step 926 comprises checking if the trailer 100 has reached it final position. If not, then step 928 is executed. Step 928 comprises checking if the required action (i.e., required command) determined at step 924 is safe to perform. Safety may be considered by using the optical sensor and optionally other additional sensors or other sensors to detect objects or obstacles. The camera images may optionally be used in combination with sensor data. The output pf the TDOSS 806 i.e., the appropriate control is continuously executed until the trailer 100 arrives at its final target position either based on the detected gesture or the determined motion of the towing vehicle 1. The control commands are ceased once the trailer is at its final position.

Step 930 is executed as an alternative to step 918 if the output of the classification from the gesture classifier or vehicle follow control classifier is determined to be a change in operation. A change in operation may comprise changing operational aspects e.g., switching on lights or activating the indicator lights etc. At step 930 a Trailer Auxiliary Operation Sub-system (TAOSS) 810, controls operational aspects of the trailer like toggling turn signals, brake lights, reversing lights, license plate lights, any central locking or similar motors which control doors and lids on the trailer. An optional confidence check 932 may be executed prior to applying the TAOSS 810. Step 932 may be similar to step 918, wherein a low confidence output results in an error being generated and/or the output being discarded. The output of the TAOSS may be fed into the dynamics and path planning sub system and the method may carry on through steps 922 onward.

The method 900 may be continuously executed and repeated. Optionally another sub-system may also be included to handle all software and power operation of computing accessories connected through any USB (Universal Serial Bus) ports or Network ports like RJ-45, WIFI or Bluetooth and Infra-red, LIDAR, Optical and other sensors that may be included in the Trailer, as well as wheel speed and feedback from the braking and movement components of the trailer system like current brake actuation/pressure, wheel velocity, power output, power regeneration etc. These may be connected to a computing device that allows various different apps and software to run and access data from the control bus to allow for new functionality to be introduced via software additions to the computing device at a later date. The computing device may include a 4G or High-speed Mobile Internet modem to allow the computing device and software running on it to have restricted or unrestricted access to the internet.

The computing device may change or add control signals to allow different software to modify the behaviour of the trailer using software logic, including taking commands from remote software through the internet via an authenticated website, mobile application or other suitable software. These commands are always routed through the DPPSS 806 of the controller 150 to ensure they are safe and effective. The various software sub systems and software engines e.g., the classifiers 802, 804, the DPPSS 806, the TDOSS 808 and the TAOSS 810 may all be stored in and executed by the controller 150.

The motors 140, 142 are driven through a motor controller which is a computing device that also includes a communication bus (like a CAN-bus) that is connected to the central controller 150. Alternatively, the central controller 150 may drive the motors directly. The CAN-bus allows communication with controller subsystems such as the DPPSS 806 which may run on the controller 150 or a further computing device. This generates a sequence of control commands using software that the motor controller can execute.

Some example commands are:
Set speed and/or power of rotation
Set direction of travel for motor (Clockwise or Counter-clockwise)
Set regeneration (power generation) on/off
Set regeneration strength
Stop the motor as fast as possible (cut power, set max regeneration)

Each of these commands could be either set to run for a given duration, or change the state of the controller so the motor holds that state until the next command comes in, or power is lost. The commands may be provided as outputs as part of method 900.

The neural networks used herein may be trained using typical training techniques to provide reliable and accurate recognition in a broad range of scenes and environmental conditions. The neural networks as utilised in classifiers are trained for object recognition e.g., recognition of gestures or motion of the towing vehicle.

The trailer may additionally comprise other sensors such as acoustic sensors e.g., ultrasonic sensors can be utilised by the controller. Additionally, the trailer may further comprise additional sensors such as for example non optical sensors e.g., magnetometers, barometers, temperature sensors. At step 902 the data frames referred to above may further comprise data frames from other sensors such as the optical sensors and the non-optical sensors described herein. The image frames at step 902 may also comprise image frames from the side cameras of the trailer that can be used for spatial data recognition.

The data from these other sensors may be processed by the controller and may be used to recognise spatial data. Spatial data may include environmental data as well as other objects within the path of the trailer or around the trailer. Spatial data may also include recognising other features such as people, other vehicles, vehicle lights, traffic signals, signal lights, car body shapes, etc. Spatial data may also include estimation of tracks of the same object e.g., the path of a particular object so the controller can determine the possibility of a collision. The cameras e.g., the side cameras and optical sensors and other sensors inputs are used by the controller to determine spatial data. The controller may implement a spatial data recognition sub system that is configured to process the received data frames from the side cameras, optical sensors and other sensors to determine spatial data.

The trailer as described herein is advantageous because the trailer utilises multiple sensors to determine a motion of a towing vehicle. The motion of towing vehicle is used to control electric motors to adjust the motion of the trailer in order to reduce the towing load. For example, if the towing vehicle is accelerating forwarding, the mechanical sensors (e.g., force sensors) and cameras and optionally other sensors are utilised to determine this acceleration and the controller controls the electric motors to accelerate the trailer forward to reduce the pulling load i.e., pulling effort on the towing vehicle. This reduces the fuel consumption as the load on the towing vehicle is reduced. This can be particularly useful for electric towing vehicles, as the reduced load from the trailer due to the electric motors increases the range of the towing vehicle. The same advantage is applicable for fuel towing vehicle as the range is increased due to the reduced loads on the towing vehicle.

The trailer as described herein uses mechanical sensors in combination with optical sensors e.g., cameras. In particular the trailer comprises a combination of mechanical sensors (force sensors) and a vision system based the cameras to provide a more accurate determination of the motion of the towing vehicle. The combination of sensors are used in synchrony to provide improved control and improve sensing. The controller can provide more accurate control to the trailer based on the improved sensing.

The description of any of these alternative embodiments is considered exemplary. Any of the alternative embodiments and features in the alternative embodiments can be used in combination with each other or with the embodiments described with respect to the figures.

The controller 150 can include programming instructions for detection of input conditions and control of output conditions. The programming instructions can be stored in the memory unit of the controller 150. The programming instructions can correspond to the methods, processes and functions described herein. The programming instructions can be executed by one or more hardware processors (not illustrated) of the controller 150. The programming instructions can be implemented in C, C++, JAVA, or any other suitable programming languages. Some or all of the portions of the programming instructions can be implemented in application specific circuitry such as ASICs and FPGAs. The controller 150 can also include circuits for receiving sensor signals. The trailer 100 may comprise a user interface e.g., a display or indicator lights that may be used to display various warnings. The warnings and alarms may also be transmitted to a user device e.g., a mobile device.

The phrases ‘computer-readable medium’ or ‘machine-readable medium’ as used in this specification and claims should be taken to include, unless the context suggests otherwise, a single medium or multiple media. Examples of multiple media include a centralised or distributed database and/or associated caches. These multiple media store the one or more sets of computer executable instructions. The phrases ‘computer-readable medium’ or ‘machine-readable medium’ should also be taken to include any medium that is capable of storing, encoding or carrying a set of instructions for execution by a processor of a computing device and that cause the processor to perform any one or more of the methods described herein. The ‘computer-readable medium’ or ‘machine-readable medium’ may be non-transitory.

The foregoing describes only some example embodiments of the present invention and modifications, obvious to those skilled in the art, can be made thereto without departing from the scope of the present invention. Modifications and variations as would be apparent to a skilled addressee are deemed to be within the scope of the present invention.

Conditional language, such as “can,” “could,” “might,” or “may,” unless specifically stated otherwise, or otherwise understood within the context as used, is generally intended to convey those certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

The term “controller” includes, but it not limited to, on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

In the above description, a memory unit i.e., a storage medium may represent one or more devices for storing data, including read-only memory (ROM), random access memory (RAM), magnetic disk storage mediums, optical storage mediums, flash memory devices and/or other machine or computer readable mediums for storing information.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

What is claimed is:

1-62. canceled

63. A trailer configured to be towed by a towing vehicle, the trailer comprising
a chassis,
a hitch to couple the trailer to a towing vehicle,
a receptacle mounted on the chassis and defining a space to hold goods;
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the at least one electric motor,
one or more force sensors mounted on the trailer,
at least one optical sensor mounted on the trailer,
a controller arranged in communication with the one or more force sensors and the at least one optical sensor, the controller configured to receive and process signals received from the force sensors and the optical sensor,
the controller electrically coupled to the electric motor and configured to control operation of the electric motor,
wherein the controller further configured to:
determine a force on the hitch applied by the towing vehicle, based on processing signals received from the one or more force sensors,
determine an orientation of the towing vehicle based on processing images received from the optical sensor,
control the electric motor based on the determined force and orientation.

64. The trailer as per claim 63, wherein the force sensors are configured to determine a linear force on the hitch, wherein the force on the hitch is applied by the towing vehicle.

65. The trailer as per claim 63, wherein the controller is configured to determine a magnitude and direction of the force on the hitch applied by the towing vehicle.

66. The trailer as per claim 64, wherein the one or more force sensors are load cells.

67. The trailer as per claim 64, wherein the trailer comprises four force sensors mounted on the hitch, the four force sensors are configured to sense a force on the hitch by the towing vehicle, and wherein the controller is configured to determine at least one or both of a magnitude and direction of a force sensed by each force sensor.

68. The trailer as per claim 63, comprising at least a pair of electric motors, each motor is mounted to one of the first wheel and second wheel, the first wheel and second wheel defining drive wheels such that the electric motor is configured to drive the wheel the motor is mounted to, based on a control signal from the controller, and wherein the controller is configured to independently control each of the electric motors independently based on the determined force and orientation of the towing vehicle.

69. The trailer as per any claim 63, wherein the controller is configured to:
determine a magnitude and direction of force from the towing vehicle on the coupling bar at each force sensor
control each electric motor independently based on the determined magnitude and direction of the detected force.

70. The trailer as per claim 63, wherein two force sensors are mounted on the hitch plate to the left of the coupling bar defining a first group of sensors, and two force sensors are mounted on the hitch plate to the right of the coupling bar defining a second group, wherein the controller is configured to:
determine a magnitude and direction of force from the towing vehicle as detected at each force sensor in the first group,
determine a magnitude and direction of force from the towing vehicle as detected at each force sensor in the second group,
determine a resultant magnitude and direction of force at the first group of sensors,
determine a resultant magnitude and direction of force at the second group of sensors,
control a first electric motor based on the resultant magnitude and direction, and control the second electric motor based on the resultant magnitude and direction, such that each wheel is driven independently.

71. The trailer as per claim 63, wherein the controller is configured to control each electric motor to accelerate or decelerate the wheel the motor is mounted to, based on the magnitude and direction of force detected by the force sensors.

72. The trailer as per claim 71, wherein the controller is configured to control each electric motor to accelerate or brake the electric motor based on the rate of change of the force detected by the one or more force sensors.

73. The trailer as per claim 63, wherein the trailer comprises at least two optical sensors mounted on the trailer and spaced apart from each other.

74. The trailer as per claim 73, wherein the controller is configured to:
determine a distance of the towing vehicle from the trailer based on the signals from the first optical sensor,
to determine a distance of the towing vehicle from the trailer based on the signals from the second optical sensor,
compare the two distance measures, and,
determine if the towing vehicle is turning based on comparing the distance measures and comparing the difference in the distance measures being above a threshold.

75. The trailer as per claim 74, wherein the towing vehicle is determined to be turning if the controller determines the distance detected by one optical sensor to be different to the distance detected by the other optical sensor and wherein the difference is greater than a threshold.

76. The trailer as per claim 75, wherein the cameras are mounted on the trailer to focus on the towing vehicle, the controller is configured to receive an image stream from the cameras and the controller configured to:
recognise the towing vehicle in the image stream by applying an object detection algorithm,
determine an orientation of the towing vehicle relative to the trailer based on recognising the towing vehicle in the image stream, wherein the orientation is determined based on comparing the position of the towing vehicle in the image stream from the first camera with the position of the towing vehicle in the image stream from the second camera,
control each electric motor independently based at least on the determined orientation of the towing vehicle.

77. The trailer as per claim 76, wherein controller is configured to determine if the towing vehicle is turning based on determined orientation of the towing vehicle and a determined distance between the towing vehicle and each camera, the controller configured to control each electric motor to cause the trailer to turn in accordance with the turning of the towing vehicle identified in the controller.

78. A trailer configured to be towed by a towing vehicle, the trailer comprising
a chassis,
a hitch to couple the trailer to a towing vehicle,
a receptacle mounted on the chassis and defining a space to hold goods,
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the motor,
a sensor assembly comprising one or more sensors configured to track a force applied by the towing vehicle and/or track movement of the towing vehicle,
a controller arranged in communication the plurality of sensors in the sensor assembly,
the controller electrically coupled to the electric motor and configured to control operation of the electric motor,
wherein the controller further configured to:
determine an orientation of the towing vehicle based on processing signals from the sensors in the sensor assembly and/or determine a force from the towing vehicle on the trailer based on processing signals from the sensors in the sensor assembly, and
control the electric motor based on the determined force and/or orientation of the towing vehicle.

79. The trailer as per claim 78, wherein the sensor assembly comprises one or more force sensors or one or more optical sensors or one or more acoustic sensors and wherein the controller is configured to determine a force applied by the towing vehicle based on signals from the one or more force sensors, and the controller further configured to determine an orientation of the signals from the one or more optical sensors, the controller configured to control the electric motor based on the force and orientation of the towing vehicle.

80. The trailer as per claim 78, wherein the trailer comprises one or more force sensors, one or more optical sensors and one or more acoustic sensors, each of the sensors arranged in communication with the controller, and the controller configured to determine at least an orientation of the towing vehicle based on processing signals from the sensors.

81. The trailer as per claim 78, wherein the controller is configured to determine a force exerted on the trailer from the towing vehicles based on processing the signals from the one or more force sensors, and the controller further configured to determine the orientation of the towing vehicle based on processing the signals from the one or more optical sensors and/or the one or more acoustic sensors.

82. A trailer configured to be towed by a towing vehicle comprising:
a chassis,
a hitch to couple the trailer to a towing vehicle,
a wheel assembly coupled to the chassis, the wheel assembly comprising at least a first wheel and a second wheel,
at least one electric motor connected to or mounted on at least one wheel, the electric motor configured to drive the at least one wheel,
at least one battery, the battery electrically coupled to the electric motor and the electric motor configured to draw power from the battery to drive the motor,
a sensor assembly comprising one or more sensors configured to sense movement of the towing vehicle,
a controller arranged in communication with the plurality of sensors in the sensor assembly,
the controller electrically coupled to the electric motor and configured to control operation of the electric motor,
wherein the controller further configured to:
determine a position of the towing vehicle based on processing signals from the sensors in the sensor assembly, and
control the electric motor based on the determined force and/or orientation of the towing vehicle.
